(19) United States
(12) Patent Application Publication
(10) Pub. No.: US 2009/0063228 A1
(43) Pub. Date: Mar. 5, 2009

(54) Method and apparatus for providing a virtual electric utility

(76) Inventor: Joseph W. Forbes, JR., Wake Forest, NC (US)

Correspondence Address: GARY ROBINSON, P. A., 401 E. LAS OLAS BLVD, SUITE 1850, FORT LAUDERDALE, FL, 33301, US

(21) Appl. No.: 12/001,819

(22) Filed: Dec. 13, 2007

Related U.S. Application Data
(63) Continuation-in-part of application No. 11/895,909, filed on Aug. 28, 2007.

(51) Int. Cl. G06Q 10/00; G06Q 30/00

(52) U.S. Cl. 705/7; 705/14; 705/1

(57) ABSTRACT

A method and apparatus for virtually generating electricity for use by electric utilities provide a virtual electric utility. In one embodiment, a non-power generating electric utility enters into a supply agreement to acquire electric power from an electric power generating entity. During a term of the agreement, the non-power generating utility intentionally refrains from receiving at least some of the electric power to which it is entitled under the agreement to produce deferred electric power. The non-power generating utility offers to supply the deferred electric power to third party, such as an electric power supplier or an electric power consumer. The power deferment is preferably achieved through issuance of power control commands to a load management system. In another embodiment, an independent third party controls the load management system to function as an alternative energy supplier by virtually supplying deferred electric power back to a power grid.

### CROSS REFERENCE TO RELATED APPLICATIONS

This application is a continuation-in-part of co-pending U.S. application Ser. No. 11/895,909 filed on Aug. 28, 2007, which application is incorporated herein by this reference as if fully set forth herein, and hereby claims priority upon such co-pending application under 35 U.S.C. § 120.

### BACKGROUND OF THE INVENTION

1. Field of the Invention

The present invention relates generally to the field of electric power supply and generation systems and, more particularly, to an apparatus and method for providing a virtual electric utility capable of supplying power virtually to other electric utilities on an as-needed basis through use of positive load control and power conservation techniques.

2. Description of Related Art

The increased awareness of the impact of carbon emissions from the use of fossil fueled electric generation combined with the increased cost of producing peak power during high load conditions has increased the need for alternative solutions utilizing load control as a mechanism to defer, or in some cases eliminate, the need for the deployment of additional generation capacity by electric utilities. Existing electric utilities are pressed for methods to defer or eliminate the need for construction of fossil-based electricity generation. Today, a patchwork of systems exist to implement demand response load management programs, whereby various radio subsystems in various frequency bands utilize “one-way” transmit only methods of communication. Under these programs, RF controlled relay switches are typically attached to a customer's air conditioner, water heater, or pool pump. A blanket command is sent out to a specific geographic area whereby all receiving units within the range of the transmitting station (e.g., typically a paging network) are turned off during peak hours at the election of the power utility. After a period of time when the peak load has passed, a second blanket command is sent to turn on those devices that have been turned off.

While tele-metering has been used for the express purpose of reporting energy usage, no techniques exist for calculating power consumption, carbon gas emissions, sulfur dioxide (SO₂) gas emissions, and/or nitrogen dioxide (NO₂) emissions, and reporting the state of a particular device under the control of a two-way positive control load management device. In particular, one way wireless communications devices have been utilized to de-activate electrical appliances, such as heating, ventilation, and air-conditioning (HVAC) units, water heaters, pool pumps, and lighting, from an existing electrical supplier or distribution partner's network. These devices have typically been used in combination with wireless paging receivers that receive “on” or “off” commands from a paging transmitter. Additionally, the one-way devices are typically connected to a serving electrical supplier's control center via landline trunks, or in some cases, microwave transmission to the paging transmitter. The customer subscribing to the load management program receives a discount for allowing the serving electrical supplier (utility) to connect to their electrical appliances and deactivate those appliances temporarily during high energy usage periods.

Many electric utilities, including power generating utilities and serving utilities, such as electric cooperatives and municipalities that typically enter into to power supply agreements with power-generating entities, are driven by the economic realities of the increasing cost of electricity production through primarily carbon based fuels (e.g., coal, oil, and natural gas) coupled with the potential damage to the environment resulting from the use of such carbon based fuels. Even with those realities, most of the focus in the electric utility industry is in two areas, namely, clean coal technologies and peak load shedding through traditional well understood methods. Such load-shedding methods employed by the electric utility industry generally include: (a) time of use programs and rates to encourage the customers to defer power consumption during peak times by manually, or through use of commercially available timers or programmable thermostats, turning off power consuming load devices, such as lights, pool pumps, and HVAC systems; (b) efficiency programs that encourage the use of more electrically efficient appliances and light bulbs and better insulation; (c) peak generation construction through which power generation companies produce power only during periods of very high peak loads (e.g., less than 10% of total load times); (d) automated load shedding programs, such as those described above, that use one way load control techniques; and (e) voluntary efficiency programs where companies or industries agree to have their loads cut or reduced for better wholesale electricity prices. Many of these techniques have primarily been utilized for industrial customers who have higher base electrical loads than residential and small/medium business customers.

As a result of these legacy peak load and base load abatement techniques, most of the prior art in the load shedding and peak power generation fields revolves around improving or creating new methods based on the aforementioned ideas. One exemplary method of generating excess demand related electricity is embodied in U.S. Patent Publication No. US 2003/0144864 A1 to Mazzarella. This publication discloses a method whereby individual power generating entities are envisioned operating a distributed power generation system compromising one or more local production units. The local production units are controlled by a central controller and brought on-line in the event of a peak load demand in excess of supply. This patent publication describes co-generation by various means including gas fired and diesel generation.

A second exemplary method of creating an economic incentive system can be found in U.S. Pat. No. 5,237,507 issued to Chasek. This patent discloses a market-driven power grid that has a centralized grid controller for the entire grid. The grid controller senses power supply and demand, and then trades this power electronically. The technique disclosed in this patent has been realized through the introduction of wholesale power markets that provide peak power which can be provided to electrical utilities that have peak demands that exceed supply on high usage days.

A third exemplary method can be found in U.S. Pat. No. 6,633,823 B2 issued to Bartone. Pursuant to the method disclosed in this patent, large consumers of power (primarily industrial customers) install proprietary hardware and software that allows the customers to have their heating/cooling, lighting, and other power intensive equipment controlled remotely to save on power consumption (and thus dropping demand). While this reference generally describes a system that would assist utilities in managing power load control, the reference does not contain the unique attributes necessary to construct or implement a complete system. In particular, this patent is deficient in the areas of security, load accuracy of a controlled device, and methods disclosing how a customer utilizing applicable hardware might set parameters, such as temperature set points, customer preference information, and customer overrides, within an intelligent algorithm that reduces the probability of customer dissatisfaction and service cancellation or churn.

While the aforementioned references provide various methods for attempting to manage the amount of electricity consumed by customers of an electric utility, the proposed methods require an influx of new hardware and software into the electrical system. As a result, the proposed methods generally require an investment in system plant and equipment. Consequently, a possibility exists that electric utilities may be reluctant to try the new technologies because their implementations pose some risk of failure. Such hesitation to try new methods is particularly true for the larger, publicly owned electric utilities that have the responsibility to provide electricity to both their own customer base, as well as to electric membership cooperatives (“electric cooperatives”) and municipalities. Electric cooperatives and municipalities primarily distribute electricity to their customers, but do not generate the distributed electricity. However, the electric cooperatives and the municipalities have the same “electric utility” designation as do electric utilities that actually generate power.

There are approximately sixty-eight (68) publicly traded electrical utilities in the United States. The majority of these large utilities have a substantial investment in existing property plant and equipment that is of known technology, being well understood by the electric power industry for decades. While the implementation of load management methods may be technically feasible using existing communications technology, the fact remains that load management, especially load disablement, may reduce the amount of electricity sold by the serving utility and thereby may reduce revenues. As a result, widespread implementation of successful load management programs may take a substantial amount of time without an additional catalyst to increase the financial benefits to electric utilities for using such load management techniques.

While the number of large publicly traded electrical utilities in the United States is relatively small, there are hundreds of electric cooperatives and municipal distribution entities that purchase power from existing power-generation utilities, generally nearby serving utilities, and resell this power to their customers within a defined service territory. The profile of these electric cooperatives and municipalities are generally Tier 2-4 cities and counties (e.g., cities and/or counties with populations from less than 5000 households to generally no greater than 100,000 households) that lie outside of metropolitan areas and were established specifically to facilitate the distribution of electricity in areas typically more expensive to provide than metropolitan areas. These electric cooperatives and municipalities generally are interconnected to the Federal Energy Regulatory Commission (“FERC”) regulated electrical grid and have direct tie lines for the receipt of electricity from a nearby generating utility. When regulated by the states' Public Utilities Commissions (“PUCs”), the electric cooperatives and municipalities often have the responsibility of supplying water, natural gas, and other services bundled for the benefit of the customer.

Electric cooperatives and municipalities generally purchase power from power-generating utilities under long-term, defined pre-purchase, wholesale contracts that set a fixed price per mega-watt hour (MWH) for both peak and non-peak periods. In most cases the pre-purchase price negotiated for these agreements are “take or pay” agreements that commit the electric cooperatives or municipality to provide the serving utility a minimum amount of generation revenue, whether this actual demand is consumed or not. While this arrangement provides the electric cooperative/municipality security and commitment for power, it also allows the serving, power-generating utility to sell excess power to other serving utilities connected to the FERC grid under peak load pricing, which is generally substantially higher per MWH than the price typically charged to customers under PUC regulated pricing. This pricing arbitrage is profitable for the serving utility, but generally, unless previously negotiated, is not passed on to the distribution partners, such as the electric cooperatives and the municipalities.

In addition to the present economics of electric power distribution, there is currently some concern about the gaseous emissions that result from the use of carbon-based fuels to generate electricity and their effect on the world's climate. As a result, some environmentalists are presently urging electric utilities and others to investigate and develop alternative sources for generating power. To address environmental concerns, so-called “carbon credits” have been created on an international scale to provide a basis for cities, states, countries, businesses, and even individuals to gauge their use of carbon-based fuels and control their associated emissions. The carbon credits may be traded among carbon-based fuel users in an attempt to maintain a global or local maximum level of carbon fuel based emissions. Markets have developed for carbon credits and the trading of carbon credits on the open market has been the subject of various proposed methods.

For instance, one exemplary method is disclosed in U.S. Patent Publication No. 2002/0143693 A1 to van Soestbergen. This publication details a technique for trading carbon credits on an open market. The publication discloses an on-line trading network, whereby carbon credits can be bought and sold electronically, preferably though a bank. Another similar carbon credit trading method is disclosed in U.S. Patent Publication No. US 2005/0246190 A1 to Sandor et al.

Under the current state of the electric utility industry, power generating utilities have the ability to sell excess power not used by their customers or contract purchasers (e.g., electric cooperatives and municipalities) and trade their unused carbon credits. However, electric cooperatives and municipalities are not so fortunate because carbon credits associated with their energy usage or savings are credited to carbon footprints of the power generating entities supplying their power. Additionally, power saved by the electric cooperatives and municipalities results in excess power available for sale by the power generating entities without any benefit to the electric cooperatives and municipalities.

Therefore, a need exists for a method and apparatus for implementing a virtual electric utility that enable independent power producers (IPPs), electric cooperatives, municipalities and other non-power generating electric utilities or other entities, whether regulated or unregulated, to benefit from power conservation and carbon footprint reduction.

### BRIEF DESCRIPTION OF THE DRAWINGS

FIG. 1 is a block diagram of an exemplary IP-based, active power load management system.

FIG. 2 is a block diagram illustrating an exemplary active load director (ALD) server as shown in the power load management system of FIG. 1.

FIG. 3 is a block diagram illustrating an exemplary active load client and smart breaker module as shown in the power load management system of FIG. 1.

FIG. 4 is an operational flow diagram illustrating a method for automatically scheduling service calls in an active power load management system, such as the power load management system of FIG. 1.

FIG. 5 is an operational flow diagram illustrating a method for activating new subscribers in an active power load management system, such as the power load management system of FIG. 1.

FIG. 6 is an operational flow diagram illustrating a method for managing events occurring in an active power load management system, such as the power load management system of FIG. 1.

FIG. 7 is an operational flow diagram illustrating a method for actively reducing consumed power and tracking power savings on an individual customer basis in an active power load management system, such as the power load management system of FIG. 1.

FIG. 8 is an operational flow diagram illustrating a method for tracking cumulative power savings of an electric utility in an active power load management system, such as the power load management system of FIG. 1.

FIG. 9 is a block diagram of a system for implementing a virtual electric utility in accordance with an exemplary embodiment of the present invention.

FIG. 10 is an operational flow diagram illustrating a method for providing a virtual electric utility in accordance with another exemplary embodiment of the present invention.

FIG. 11 is an operational flow diagram illustrating an alternative method for providing a virtual utility in accordance with another embodiment of the present invention.

### DETAILED DESCRIPTION OF EXEMPLARY EMBODIMENTS

Before describing in detail exemplary embodiments that are in accordance with the present invention, it should be observed that the embodiments reside primarily in combinations of apparatus components and processing steps related to actively managing power loading on an individual subscriber basis and optionally tracking power savings incurred by both individual subscribers and an electric utility. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, may be used solely to distinguish one entity or element from another entity or element without necessarily requiring or implying any physical or logical relationship or order between such entities or elements. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. The term “plurality of” as used in connection with any object or action means two or more of such object or action. A claim element proceeded by the article “a” or “an” does not, without more constraints, preclude the existence of additional identical elements in the process, method, article, or apparatus that includes the element. Additionally, the term “ZigBee” refers to any wireless communication protocol adopted by the Institute of Electronics & Electrical Engineers (IEEE) according to standard 802.15.4 or any successor standard(s), the term “Wi-Fi” refers to any communication protocol adopted by the IEEE under standard 802.11 or any successor standard(s), the term “WiMax” refers to any communication protocol adopted by the IEEE under standard 802.16 or any successor standard(s), and the term “Bluetooth” refers to any short-range communication protocol implementing IEEE standard 802.15.1 or any successor standard(s). The term “High Speed Packet Data Access (HSPA)” refers to any communication protocol adopted by the International Telecommunication Union (ITU) or another mobile telecommunications standards body referring to the evolution of the Global System for Mobile Communications (GSM) standard beyond its third generation Universal Mobile Telecommunications System (UMTS) protocols. The term “Long Term Evolution (LTE)” refers to any communication protocol adopted by the ITU or another mobile telecommunications standards body referring to the evolution of GSM-based networks to voice, video and data standards anticipated to be replacement protocols for HSPA. The term “Code Division Multiple Access (CDMA) Evolution Date-Optimized (EVDO) Revision A (CDMA EVDO Rev. A)” refers to the communication protocol adopted by the ITU under standard number TIA-856 Rev. A. The term “electric utility” refers to any entity that generates and distributes electrical power to its customers, that purchases power from a power-generating entity and distributes the purchased power to its customers, or that supplies electricity created by alternative energy sources, such as solar power, wind power or otherwise, to power generation or distribution entities through the FERC electrical grid or otherwise.

It will be appreciated that embodiments or components of the systems described herein may be comprised of one or more conventional processors and unique stored program instructions that control the one or more processors to implement, in conjunction with certain non-processor circuits, some, most, or all of the functions for managing power load distribution and tracking individual subscriber power consumption and savings in one or more power load management systems as described herein. The non-processor circuits may include, but are not limited to, radio receivers, radio transmitters, antennas, modems, signal drivers, clock circuits, power source circuits, relays, meters, smart breakers, current sensors, and user input devices. As such, these functions may be interpreted as steps of a method to distribute information and control signals between devices in a power load management system. Alternatively, some or all functions could be implemented by a state machine that has no stored program instructions, or in one or more application specific integrated circuits (ASICs), in which each function or some combinations of functions are implemented as custom logic. Of course, a combination of the two approaches could be used. Thus, methods and means for these functions have been described herein. Further, it is expected that one of ordinary skill in the art, notwithstanding possibly significant effort and many design choices motivated by, for example, available time, current technology, and economic considerations, when guided by the concepts and principles disclosed herein, will be readily capable of generating such software instructions, programs and integrated circuits (ICs), and appropriately arranging and functionally integrating such non-processor circuits, without undue experimentation.

Generally, the present invention encompasses a method and apparatus for implementing or providing a virtual electric utility that provides an alternative energy source through deferment or conservation of electric power. In one embodiment, a non-power generating utility, such as an electric cooperative or a municipality, or other power distribution-related entity enters into an agreement with an electric power generating entity to acquire electric power. During the term of the agreement, the power purchasing entity intentionally refrains from receiving at least some of the electric power to which it is entitled under the agreement to produce deferred electric power. The power purchasing entity then at least offers to supply the deferred electric power to an electric power supplier, which may be the power generating electric utility or any other electric utility, or an electric power consumer, which may be commercial or residential in nature. In other words, the power purchasing entity acts as a virtual power generating utility by offering to sell its deferred (or equivalently conserved or curtailed) power to other utilities or end consumers. For example, the power purchasing entity offers to sell or, more preferably sells, its entitlement to the power under the supply agreement to another utility or an end user. The purchasing utility may be an adjacent electric utility, such as an electric utility supplying electric power to the geographic area (e.g., county or state) in which the virtual utility resides, or a non-adjacent electric utility, such as an electric utility supplying electric power to a geographic area (e.g., county or state) other than that in which the virtual utility resides. In the latter case, the virtual utility may transfer the deferred power by reserving transmission capacity over the FERC electrical grid for transmission of the deferred power to which the virtual utility is entitled from the generating entity to the purchasing entity in a manner similar to the sale of generated power by independent power producers (IPPs). Alternatively, the purchasing consumer or end user may be a business entity (e.g., a manufacturing plant or series of manufacturing plants) or a residential entity (e.g., a condominium association or a neighborhood homeowner's association). The consideration for the sale can be monetary or non-monetary (e.g., future entitlement to power, carbon credits, or any other consideration deemed valuable by the parties). Optimally, the virtual utility sells the deferred power during peak periods at a premium, thereby providing a monetary benefit to the virtual utility, which may then be passed on to its customers. The virtual utility would also have the right to reserve transmission capacity along a FERC interconnected transmission line (as do power generating utilities currently) and have the right to sell wholesale and retail power generation contracts to other FERC interconnected utilities, whereby the generated power is verified conservation or load curtailment.

In another embodiment, the virtual electric utility utilizes a load management system to temporarily turn off power to some or all of its customers as agreed upon by the customers and according to a power reduction protocol. A primary goal of a load management system is the aggregation of deferred (or equivalently conserved or curtailed) power from many customers to accumulate substantial power deferments. Through the accumulation or aggregation of deferred power, the virtual utility may be recognized as an alternative energy provider as defined by each state's or federal requirements, and thereby be permitted to sell deferred power (e.g., power shed during peak hours) to electric utilities or electric power consumers within each regulating state or that share or utilize the FERC electrical grid. In an alternative embodiment, the virtual utility may sell its deferred power or carbon credits to energy “middlemen” or wholesale producers who are licensed in the state or geographic locations of the virtual utility or whose physical location is different than that of the power generating entity with which the virtual utility has a power supply agreement.

In yet another embodiment, the virtual electric utility employs a load management system to control power distribution and deferment. In this embodiment, customers agree to allow the power management system to disable certain power-consuming devices during peak loading times of the day. Smart breakers, which have the ability to be switched on or off remotely, are installed for specific devices in an electric service control panel accessed by a known IP address. Alternatively, IP-addressable smart appliances, IP addressable relays, controllable thermostats or other variable controls, or energy efficiency computer operated programs may be used. The virtual utility can verify the actual load curtailment or shed during a conservation period by employing such IP-addressable devices to actually remove power from the electric grid and supply the “state” of the device (e.g., on, off, curtailed, or controlled) to a controlling apparatus, which in turn may provide verification to the virtual utility. The power management system determines the amount of steady-state power each device consumes when turned on and logs the information in a database for each subscriber. For example, a current sensor or any power measurement device on each smart appliance or within each smart breaker may measure the amount of current consumed by each monitored device. A client device then multiplies the amount of current consumed by the operating voltage of the device to obtain the power consumption, and transmits the power consumption to a server of the virtual utility. When a serving utility needs more power than it is currently able to supply, the serving utility may request to purchase power from the virtual electric utility, which, either responsive to the power purchase request or in anticipation of a power purchase request, activates the power load management system to automatically adjust the power distribution by turning off specific loads on an individual subscriber basis. Because the amount of power consumed by each specific load is known, the system can determine precisely which loads to turn off and tracks the power savings generated by each customer as a result of this short-term outage. This same method could also be accomplished though the measurement of actual power consumed during the installation of a controllable relay and cross referenced with the original equipment manufacturer's (OEM's) Underwriters Laboratories power consumption information for the controlled device. Pursuant to this embodiment, the combination of a power load measurement by an electrician and the OEM's design load would be sufficient, in the absence of a current measuring device incorporated in the relay, to provide actual power deferment or conservation data to the virtual utility. In this embodiment, the virtual electric utility may be completely independent of the electric utility that actually supplies the electrical power to the customer. For example, the virtual electric utility may be a third party that supplies the power load management system hardware to the customers and operates the power load management system or a substantial portion of it. Through operation of the power load management system, the third party selectively reduces power consumption by the customers and thereby aggregates conserved or deferred power, which is then sold to other electrical utilities or to end consumers as an alternative form of energy in the same class as solar power, wind power, hydropower or other environmentally friendly forms of energy.

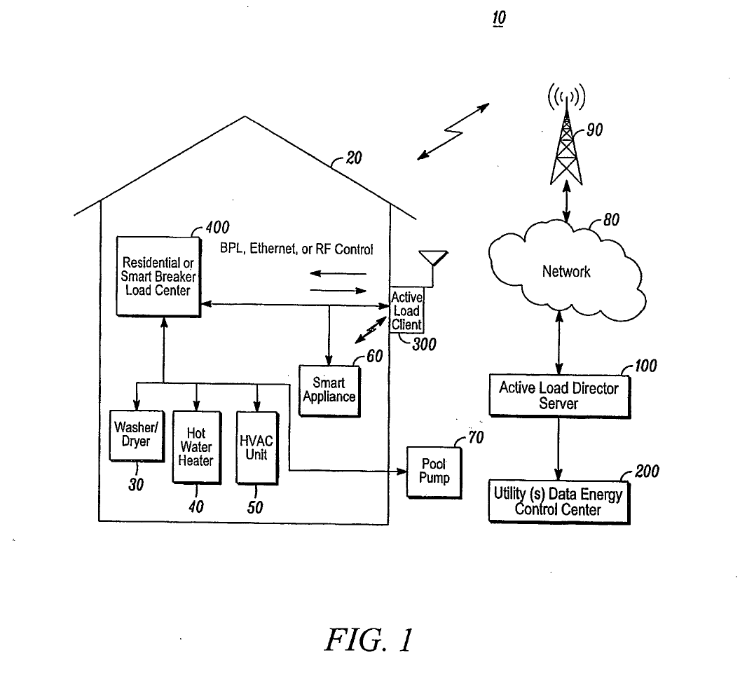

The present invention can be more readily understood with reference to FIGS. 1-11, in which like reference numerals designate like items. FIG. 1 depicts an exemplary IP-based active power load management system 10 that may be utilized by a virtual utility in accordance with the present invention. The exemplary power management system 10 monitors and manages power distribution via an active load director (ALD) server 100 connected between one or more utility control centers (UCCs) 200 (one shown) and one or more active load clients (ALCs) 300 (one shown). The ALD server 100 may communicate with the utility control center 200 and each active load client 300 either directly or through a network 80 using the Internet Protocol (IP) or any other connection-based protocols. For example, the ALD server 100 may communicate using RF systems operating via one or more base stations 90 (one shown) using one or more wireless communication protocols, such as GSM, Enhanced Data GSM Environment (EDGE), HSPA, LTE, Time Division Multiple Access (TDMA), or CDMA data standards, including CDMA 2000, CDMA Revision A, CDMA Revision B, and CDMA EVDO Rev. A. Alternatively, or additionally, the ALD server 100 may communicate via a digital subscriber line (DSL) capable connection, cable television based IP capable connection, or any combination thereof. In the exemplary embodiment shown in FIG. 1, the ALD server 100 communicates with one or more active load clients 300 using a combination of traditional IP-based communication (e.g., over a trunked line) to a base station 90 and a wireless channel implementing the WiMax protocol for the “last mile” from the base station 90 to the active load client 300.

Each active load client 300 is accessible through a specified address (e.g., IP address) and controls and monitors the state of individual smart breaker modules or intelligent appliances 60 installed in the business or residence 20 to which the active load client 300 is associated (e.g., connected or supporting). Each active load client 300 is associated with a single residential or commercial customer. In one embodiment, the active load client 300 communicates with a residential load center 400 that contains smart breaker modules, which are able to switch from an “ON” (active) state to an “OFF” (inactive), and vice versa, responsive to signaling from the active load client 300. Smart breaker modules may include, for example, smart breaker panels manufactured by Schneider Electric SA under the trademark “Square D” or Eaton Corporation under the trademark “Cutler-Hammer” for installation during new construction. For retro-fitting existing buildings, smart breakers having means for individual identification and control may be used. Typically, each smart breaker controls a single appliance (e.g., a washer/dryer 30, a hot water heater 40, an HVAC unit 50, or a pool pump 70).

Additionally, the active load client 300 may control individual smart appliances directly (e.g., without communicating with the residential load center 300) via one or more of a variety of known communication protocols (e.g., IP, Broadband over PowerLine (BPL) in its various forms, including through specifications promulgated or being developed by the HOMEPLUG Powerline Alliance and the Institute of Electrical and Electronic Engineers (IEEE), Ethernet, Bluetooth, ZigBee, Wi-Fi, WiMax, etc.). Typically, a smart appliance 60 includes a power control module (not shown) having communication abilities. The power control module is installed in-line with the power supply to the appliance, between the actual appliance and the power source (e.g., the power control module is plugged into a power outlet at the home or business and the power cord for the appliance is plugged into the power control module). Thus, when the power control module receives a command to turn off the appliance 60, it disconnects the actual power supplying the appliance 60. Alternatively, a smart appliance 60 may include a power control module integrated directly into the appliance, which may receive commands and control the operation of the appliance directly (e.g., a smart thermostat may perform such functions as raising or lowering the set temperature, switching an HVAC unit on or off, or switching a fan on or off).

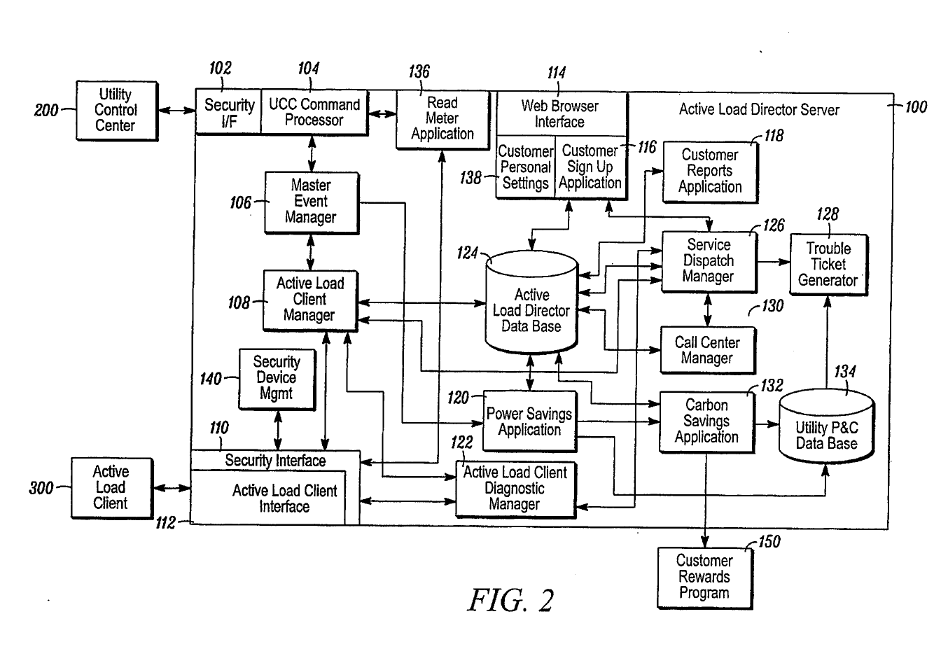

Referring now to FIG. 2, the ALD server 100 may serve as the primary interface to customers, as well as to service personnel. In the exemplary embodiment depicted in FIG. 2, the ALD server 100 includes a utility control center (UCC) security interface 102, a UCC command processor 104, a master event manager 106, an ALC manager 108, an ALC security interface 110, an ALC interface 112, a web browser interface 114, a customer sign-up application 116, customer personal settings 138, a customer reports application 118, a power savings application 120, an ALC diagnostic manager 122, an ALD database 124, a service dispatch manager 126, a trouble ticket generator 128, a call center manager 130, a carbon savings application 132, a utility P & C database 134, a read meter application 136, and a security device manager 140.

Using the web browser interface 114, in one embodiment, customers interact with the ALD server 100 and subscribe to some or all of the services offered by the power load management system 10 via a customer sign-up application 116. In accordance with the customer sign-up application 116, the customer specifies customer personal settings 138 that contain information relating to the customer and the customer's residence or business, and defines the extent of service to which the customer wishes to subscribe. Additional details of the customer sign-up application 116 are discussed below. Customers may also use the web browser interface 114 to access and modify information pertaining to their existing accounts.

The ALD server 100 also includes a UCC security interface 102 which provides security and encryption between the ALD server 100 and a utility company's control center 200 to ensure that no third party is able to provide unauthorized directions to the ALD server 100. A UCC command processor 104 receives and sends messages between the ALD server 100 and the utility control center 200. Similarly, an ALC security interface 110 provides security and encryption between the ALD server 100 and each active load client 300 on the system 10, ensuring that no third parties can send directions to, or receive information from, the active load client 300. The security techniques employed by the ALC security interface 110 and the UCC security interface 102 may include conventional symmetric key or asymmetric key algorithms, such as Wireless Encryption Protocol (WEP), Wi-Fi Protected Access (WPA and WPA2), Advanced Encryption Standard (AES), Pretty Good Privacy (PGP), or proprietary encryption techniques.

In one embodiment, the commands that can be received by the UCC command processor 104 from the electric utility's control center 200 include a “Cut” command, a “How Much” command, an “End Event” command, and a “Read Meters” command. The “Cut” command instructs the ALD server 100 to reduce a specified amount of power for a specified amount of time. The specified amount of power may be an instantaneous amount of power or an average amount of power consumed per unit of time. The “Cut” command may also optionally indicate general geographic areas or specific locations for power load reduction. The “How Much” command requests information for the amount of power (e.g., in megawatts) that can be reduced by the requesting utility control center 200. The “End Event” command stops the present ALD server 100 transaction. The “Read Meters” command instructs the ALD server 100 to read the meters for all customers serviced by the requesting utility.

The UCC command processor 104 may send a response to a “How Much” command or an “Event Ended” status confirmation to a utility control center 200. A response to a “How Much” command returns an amount of power that can be cut. An “Event Ended” acknowledgement message confirms that the present ALD server transaction has ended.

The master event manager 106 maintains the overall status of the power load activities controlled by the power management system 10. The master event manager 106 maintains a separate state for each utility that is controlled (when multiple utilities are controlled) and tracks the current power usage within each utility. The master event manager 106 also tracks the management condition of each utility (e.g., whether or not each utility is currently being managed). The master event manager 106 receives instructions in the form of transaction requests from the UCC command processor 104 and routes instructions to components necessary to complete the requested transaction, such as the ALC manager 108 and the power savings application 120.

The ALC manager 108 routes instructions between the ALD server 100 and each active load client 300 within the system 10 through an ALC interface 112. For instance, the ALC manager 108 tracks the state of every active load client 300 serviced by specified utilities by communicating with the active load client 300 through an individual IP address. The ALC interface 112 translates instructions (e.g., transactions) received from the ALC manager 108 into the proper message structure understood by the targeted active load client 300 and then sends the message to the active load client 300. Likewise, when the ALC interface 112 receives messages from an active load client 300, it translates the message into a form understood by the ALC manager 108 and routes the translated message to the ALC manager 108.

The ALC manager 108 receives from each active load client 300 that it services, either periodically or responsive to polling messages sent by the ALC manager 108, messages containing the present power consumption and the status (e.g., “ON” or “OFF”) of each device controlled by the active load client 300. Alternatively, if individual device metering is not available, then the total power consumption and load management status for the entire active load client 300 may be reported. The information contained in each status message is stored in the ALD database 124 in a record associated with the specified active load client 300. The ALD database 124 contains all the information necessary to manage every customer account and power distribution. In one embodiment, the ALD database 124 contains customer contact information, such as names, addresses, phone numbers, email addresses, and associated utility companies for all customers having active load clients 300 installed at their residences or businesses, as well as a description of specific operating instructions for each managed device (e.g., IP-addressable smart breaker or appliance), device status, and device diagnostic history.

There are several types of messages that the ALC manager 108 may receive from an active load client 300 and process accordingly. One such message is a security alert message. A security alert message originates from an optional security or safety monitoring system installed in the residence or business and coupled to the active load client 300 (e.g., wirelessly or via a wired connection). When a security alert message is received, the ALC manager 108 accesses the ALD database 124 to obtain routing information for determining where to send the alert, and then sends the alert as directed. For example, the ALD manager 108 may be programmed to send the alert or another message (e.g., an electronic mail message or a pre-recorded voice message) to a security monitoring service company and/or the owner of the residence or business.

Another message communicated between an active load client 300 and the ALC manager 108 is a report trigger message. A report trigger message alerts the ALD server 100 that a predetermined amount of power has been consumed by a specific device monitored by an active load client 300. When a report trigger message is received from an active load client 300, the ALC manager 108 logs the information contained in the message in the ALD database 124 for the customer associated with the information-supplying active load client 300. The power consumption information is then used by the ALC manager 108 to determine the active load client(s) 300 to which to send a power reduction or “Cut” message during a power reduction event.

Yet another message exchanged between an active load client 300 and the ALC manager 108 is a status response message. A status response message reports the type and status of each device controlled by the active load client 300 to the ALD server 100. When a status response message is received from an active load client 300, the ALC manager 108 logs the information contained in the message in the ALD database 124.

In one embodiment, upon receiving instructions (e.g., a “Cut” instruction) from the master event manager 106 to reduce power consumption for a specified utility, the ALC manager 108 determines which active load clients 300 and/or individually controlled devices to switch to the “OFF” state based upon present power consumption data stored in the ALD database 124. The ALC manager 108 then sends a message to each selected active load client 300 containing instructions to turn off all or some of the devices under the active load client's control.

In another embodiment, a power savings application 120 may be optionally included to calculate the total amount of power saved by each utility during a power reduction event (referred to herein as a “Cut event”), as well as the amount of power saved for each customer whose active load client 300 reduced the amount of power delivered. The power savings application 120 accesses the data stored in the ALD database 124 for each customer serviced by a particular utility and stores the total cumulative power savings (e.g., in megawatts per hour) accumulated by each utility for each Cut event in which the utility participated as an entry in the utility Power and Carbon (“P&C”) database 134.

In a further embodiment, an optional carbon savings application 132 uses the information produced by the power savings application 120 to determine the amount of carbon saved by each utility and by each customer for every Cut event. Carbon savings information (e.g., type of fuel that was used to generate power for the customer set that was included in the just completed event, power saved in the prior event, governmental standard calculation rates, and/or other data, such as generation mix per serving utility and geography of the customer's location and the location of the nearest power source) is stored in the ALD database 124 for each active load client 300 (customer) and in the utility P&C database 134 for each utility. The carbon savings application 132 calculates the total equivalent carbon credits saved for each active load client 300 (customer) and utility participating in the previous Cut event, and stores the information in the ALD database 124 and the utility P&C database 134, respectively.

Additionally, the ALC manager 108 automatically provides for smooth operation of the entire power load management system 10 by optionally interacting with a service dispatch manager 126. For example, when a new customer subscribes to participate in the power load management system 10, the service dispatch manager 126 is notified of the new subscription from the customer sign-up application 116. The service dispatch manager 126 then sends an activation request to the ALC manager 108. Upon receiving the activation request from the service dispatch manager 126, the ALC manager 108 sends a query request for information to the new active load client 300 and, upon receipt of the information, provides it to the service dispatch manager 126. Additionally, if at any time the ALC manager 108 detects that a particular active load client 300 is not functioning properly, the ALC manager 108 may send a request for service to the service dispatch manager 126 to arrange for a service call to correct the problem.

In another embodiment, the service dispatch manager 126 may also receive requests for service from a call center manager 130 that provides support to an operations center (not shown), which receives telephone calls from customers of the power load management system 10. When a customer calls the operations center to request service, the call center manager 130 logs the service call in the ALD database 124 and sends a “Service” transaction message to the service dispatch manager 126. When the service call has been completed, the call center manager 130 receives a completed notification from the service dispatch manager 126 and records the original service call as “closed” in the ALD database 124.

In yet another embodiment, the service dispatch manager 126 may also instruct an ALC diagnostic manager 122 to perform a series of diagnostic tests for any active load client 300 for which the service dispatch manager 126 has received a service request. After the ALC diagnostic manager 122 has performed the diagnostic procedure, it returns the results to the service dispatch manager 126. The service dispatch manager 126 then invokes a trouble ticket generator 128 to produce a report (e.g., trouble ticket) that includes information (some of which was retrieved by the service dispatch manager 126 from the ALD database 124) pertaining to the required service (e.g., customer name, address, any special consideration for accessing the necessary equipment, and the results of the diagnostic process). A residential customer service technician may then use the information provided in the trouble ticket to select the type of equipment and replacement parts necessary for performing a service call.

A read meter application 136 may be optionally invoked when the UCC command processor 104 receives a “Read Meters” or equivalent command from the utility control center 200. The read meter application 136 cycles through the ALD database 124 and sends a read meter message or command to each active load client 300, or those active load clients 300 specifically identified in the UCC's command, via the ALC manager 108. The information received by the ALC manager 108 from the active load client 300 is logged in the ALD database 124 for each customer. When all the active load client meter information has been received, the information is sent to the requesting utility control center 200 using a business to business (e.g., ebXML) or other desired protocol.

The optional security device management block 140 includes program instructions for handling security system messages received by the security interface 110. The security device management block 140 includes routing information for all security system messages and may further include messaging options on a per customer or service company basis. For example, one security service may require an email alert from the ALD server 100 upon the occurrence of a security event; whereas, another security service may require that the message sent from the in-building system be passed on by the active load client 300 and the ALD server 100 directly to the security service company.

In a further embodiment, the ALD server 100 also includes a customer reports application 118 that generates reports to be sent to individual customers detailing the amount of power saved during a previous billing cycle. Each report may contain a cumulative total of power savings over the prior billing cycle, details of the amount of power saved per controlled device (e.g., breaker or appliance), power savings from utility directed events, power savings from customer directed events, devices being managed, total carbon equivalents used and saved during the period, and/or specific details for each Cut event in which the customer's active load client 300 participated. Customers may also receive incentives and awards for participation in the power load management system 10 through a customer rewards program 150. For example, the utilities or a third party system operator may enter into agreements with product and/or service providers to offer system participants discounts on products and services offered by the providers based upon certain participation levels or milestones. The rewards program 150 may be setup in a manner similar to conventional frequent flyer programs in which points are accumulated for power saved (e.g., one point for each megawatt saved or deferred) and, upon accumulation of predetermined levels of points, the customer can select a product or service discount. Alternatively, a serving utility may offer a customer a rate discount for participating in the system 10.

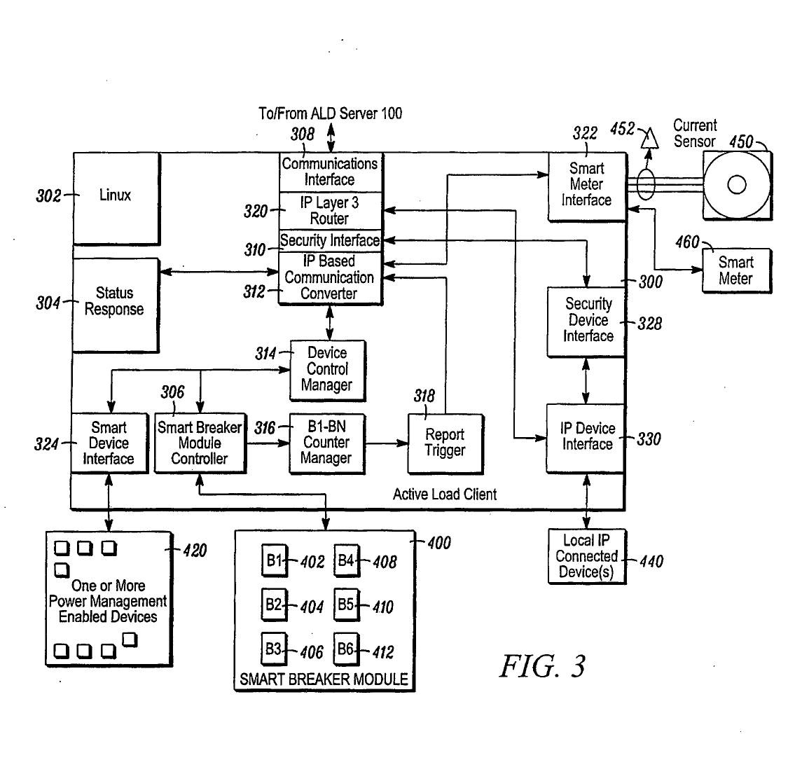

FIG. 3 illustrates a block diagram of an exemplary active load client 300 in accordance with one embodiment of the present invention. The depicted active load client 300 includes a Linux-based operating system 302, a status response generator 304, a smart breaker module controller 306, a smart device interface 324, a communications interface 308, a security interface 310, an IP-based communication converter 312, a device control manager 314, a smart breaker (B1-BN) counter manager 316, a report trigger application 318, an IP router 320, a smart meter interface 322, a security device interface 328, and an IP device interface 330. The active load client 300, in this embodiment, is a computer or processor-based system located on-site at a customer's residence or business. The primary function of the active load client 300 is to manage the power load levels of controllable, power consuming load devices located at the residence or business, which the active load client 300 oversees on behalf of the customer. In an exemplary embodiment, the software running on the active load client 300 operates using the Linux embedded operating system 302 to manage the hardware and the general software environment. One skilled in the art will readily recognize that other operating systems, such as Microsoft's family of operating systems, Mac OS, and Sun OS, among others, may be alternatively used. Additionally, the active load client 300 may include dynamic host configuration protocol (DHCP) client functionality to enable the active load client 300 to dynamically request IP addresses for itself and/or one or more controllable devices 402-412, 420, 460 managed thereby from a DHCP server on the host IP network facilitating communications between the active load client 300 and the ALD server 100. The active load client 300 may further include router functionality and maintain a routing table of assigned IP addresses in a memory of the active load client 300 to facilitate delivery of messages from the active load client 300 to the controllable devices 402-412, 420, 460.

A communications interface 308 facilitates connectivity between the active load client 300 and the ALD server 100. Communication between the active load client 300 and the ALD server 100 may be based on any type of IP or other connection protocol, including but not limited to, the WiMax protocol. Thus, the communications interface 308 may be a wired or wireless modem, a wireless access point, or other appropriate interface.

A standard IP Layer-3 router 320 routes messages received by the communications interface 308 to both the active load client 300 and to any other locally connected device 440. The router 320 determines if a received message is directed to the active load client 300 and, if so, passes the message to a security interface 310 to be decrypted. The security interface 310 provides protection for the contents of the messages exchanged between the ALD server 100 and the active load client 300. The message content is encrypted and decrypted by the security interface 310 using, for example, a symmetric encryption key composed of a combination of the IP address and GPS data for the active load client 300 or any other combination of known information. If the message is not directed to the active load client 300, then it is passed to the IP device interface 330 for delivery to one or more locally connected devices 440. For example, the IP router 320 may be programmed to route power load management system messages as well as conventional Internet messages. In such a case, the active load client 300 may function as a gateway for Internet service supplied to the residence or business instead of using separate Internet gateways or routers.

An IP based communication converter 312 opens incoming messages from the ALD server 100 and directs them to the appropriate function within the active load client 300. The converter 312 also receives messages from various active load client 300 functions (e.g., a device control manager 314, a status response generator 304, and a report trigger application 318), packages the messages in the form expected by the ALD server 100, and then passes them on to the security interface 310 for encryption.

The device control manager 314 processes power management commands for various controllable devices logically connected to the active load client 300. The devices can be either smart breakers 402-412 or other IP based devices 420, such as smart appliances with individual control modules (not shown). The device control manager 314 also processes “Query Request” or equivalent commands or messages from the ALD server 100 by querying a status response generator 304 which maintains the type and status of each device controlled by the active load client 300, and providing the statuses to the ALD server 100. The “Query Request” message may include information other than mere status requests, such as temperature set points for thermally controlled devices, time intervals during which load control is permitted or prohibited, dates during which load control is permitted or prohibited, and priorities of device control (e.g., during a power reduction event, hot water heater and pool pump are turned off before HVAC unit is turned off). If temperature set points or other non-status information are included in a “Query Request” message and there is a device attached to the active load client 300 that can process the information, the temperature set points or other information are sent to that device 420 via a smart device interface 324.

The status response generator 304 receives status messages from the ALD server 100 and, responsive thereto, polls each controllable, power consuming device 402-412, 420, 460 under the active load client's control to determine whether the controllable device 402-412, 420, 460 is active and in good operational order. Each controllable device 402-412, 420, 460 responds to the polls with operational information (e.g., activity status and/or error reports) in a status response message. The active load client 300 stores the status responses in a memory associated with the status response generator 304 for reference in connection with power reduction events.

The smart device interface 324 facilitates IP or other address-based communications to individual devices 420 (e.g., smart appliance power control modules) that are attached to the active load client 300. The connectivity can be through one of several different types of networks, including but not limited to, BPL, ZigBee, Wi-Fi, Bluetooth, or direct Ethernet communications. Thus, the smart device interface 324 is a modem adapted for use in or on the network connecting the smart devices 420 to the active load client 300. The smart device interface 324 also allows the device control manager 314 to manage those devices that have the capability to sense temperature settings and respond to temperature variations.

The smart breaker module controller 306 formats, sends, and receives messages, including power control instructions, to and from the smart breaker module 400. In one embodiment, the communications is preferably through a BPL connection. In such embodiment, the smart breaker module controller 306 includes a BPL modem and operations software. The smart breaker module 400 contains individual smart breakers 402-412, wherein each smart breaker 402-412 includes an applicable modem (e.g., a BPL modem when BPL is the networking technology employed) and is preferably in-line with power supplied to a single appliance or other device. The B1-BN counter manager 316 determines and stores real time power usage for each installed smart breaker 402-412. For example, the counter manager 316 tracks or counts the amount of power used by each smart breaker 402-412 and stores the counted amounts of power in a memory of the active load client 300 associated with the counter manager 316. When the counter for any breaker 402-412 reaches a predetermined limit, the counter manager 316 provides an identification number corresponding to the smart breaker 402-412 and the corresponding amount of power (power number) to the report trigger application 318. Once the information is passed to the report trigger application 318, the counter manager 316 resets the counter for the applicable breaker 402-412 to zero so that information can once again be collected. The report trigger application 318 then creates a reporting message containing identification information for the active load client 300, identification information for the particular smart breaker 402-412, and the power number, and sends the report to the IP based communication converter 312 for transmission to the ALD server 100.

The smart meter interface 322 manages either smart meters 460 that communicate using BPL or a current sensor 452 connected to a traditional power meter 450. When the active load client 300 receives a “Read Meters” command or message from the ALD server 100 and a smart meter 460 is attached to the active load client 300, a “Read Meters” command is sent to the meter 460 via the smart meter interface 322 (e.g., a BPL modem). The smart meter interface 322 receives a reply to the “Read Meters” message from the smart meter 460, formats this information along with identification information for the active load client 300, and provides the formatted message to the IP based communication converter 312 for transmission to the ALD server 100.

A security device interface 328 transfers security messages to and from any attached security device. For example, the security device interface 328 may be coupled by wire or wirelessly to a monitoring or security system that includes motion sensors, mechanical sensors, optical sensors, electrical sensors, smoke detectors, carbon monoxide detectors, and/or other safety and security monitoring devices. When the monitoring system detects a security or safety problem (e.g., break-in, fire, excessive carbon monoxide levels), the monitoring system sends its alarm signal to the security interface 328, which in turn forwards the alarm signal to the IP network through the ALD server 100 for delivery to the target IP address (e.g., the security monitoring service provider). The security device interface 328 may also be capable of communicating with the attached security device through the IP device interface to recognize a notification message from the device that it has lost its line based telephone connection. Once that notification has been received, an alert message is formatted and sent to the ALD server 100 through the IP based communication converter 312.

Operation of the power load management system 10 in accordance with exemplary embodiments will now be described. In one embodiment, customers initially sign up for power load management services using a web browser. Using the web browser, the customer accesses a power management system provider's website through the web browser interface 114 and provides his or her name and address information, as well as the type of equipment he or she would like to have controlled by the power load management system 10 to save energy at peak load times and to accumulate power savings or carbon credits (which may be used to receive reward incentives based upon the total amount of power or carbon saved by the customer). The customer may also agree to allow management of power consumption during non-peak times to sell back excess power to the utility, while simultaneously accumulating power savings or carbon credits.

The customer sign up application 116 creates a database entry for each customer in the ALD database 124. Each customer's contact information and load management preferences are stored or logged in the database 124. For example, the customer may be given several simple options for managing any number of devices or a class of devices, including parameters for managing the devices (e.g., how long each type of device may be switched off and/or define hours when the devices may not be switched off at all). In particular, the customer may also be able to provide specific parameters for HVAC operations (e.g., set control points for the HVAC system specifying both the low and high temperature ranges). Additionally, the customer may be given an option of receiving a notification (e.g., an email message, instant message, text message, or recorded phone call, or any combination thereof) when a power management event occurs. When the customer completes entering data, a “New Service” or equivalent transaction message or command is sent to the service dispatch manager 126.

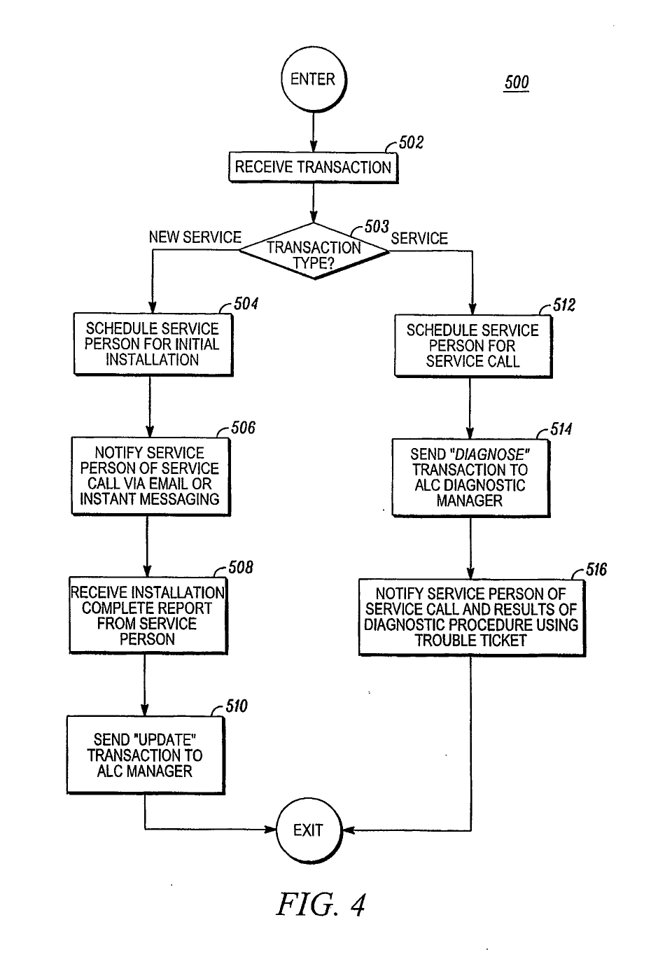

FIG. 4 illustrates an exemplary operational flow diagram 500 providing steps executed by the ALD server 100 (e.g., as part of the service dispatch manager 126) to manage service requests in the exemplary power load management system 10. The steps of FIG. 4 are preferably implemented as a set of computer instructions (software) stored in a memory (not shown) of the ALD server 100 and executed by one or more processors (not shown) of the ALD server 100. Pursuant to the logic flow, the service dispatch manager 126 receives (502) a transaction message or command and determines (503) the type of transaction. Upon receiving a “New Service” transaction message, the service dispatch manager 126 schedules (504) a service person (e.g., technician) to make an initial installation visit to the new customer. The service dispatch manager 126 then notifies (506) the scheduled service person, or dispatcher of service personnel, of an awaiting service call using, for example, email, text messaging, and/or instant messaging notifications.

In one embodiment, responsive to the service call notification, the service person obtains the new customer's name and address, a description of the desired service, and a service time from a service dispatch manager service log. The service person obtains an active load client 300, all necessary smart breaker modules 402-412, and all necessary smart switches to install at the customer location. The service person notes any missing information from the customer's database information (e.g., the devices being controlled, type make and model of each device, and any other information the system will need to function correctly). The service person installs the active load client 300 and smart breakers 402-412 at the new customer's location. A global positioning satellite (GPS) device may optionally be used by the service person to determine an accurate geographic location of the new customer's building, which will be added to the customer's entry in the ALD database 124 and may be used to create a symmetric encryption key to facilitate secure communications between the ALD server 100 and the active load client 300. The physical location of the installed active load client 300 is also entered into the customer's entry. Smart switch devices may be installed by the service person or left at the customer location for installation by the customer. After the active load client 300 has been installed, the service dispatch manager 126 receives (508) a report from the service person, via a service log, indicating that the installation is complete. The service dispatch manager 126 then sends (510) an “Update” or equivalent transaction message to the ALC manager 108.

Returning to block 503, when a “Service” or similar transaction message or command is received, the service dispatch manager 126 schedules (512) a service person to make a service call to the specified customer. The service dispatch manager 126 then sends (514) a “Diagnose” or similar transaction to the ALC diagnostic manager 122. The ALC diagnostic manager 122 returns the results of the diagnostic procedure to the service dispatch manager 126, which then notifies (516) the service person of the service call and provides him or her with the results of the diagnostic procedure using a conventional trouble ticket. The service person uses the diagnostic procedure results in the trouble ticket to select the type of equipment and replacement parts necessary for the service call.

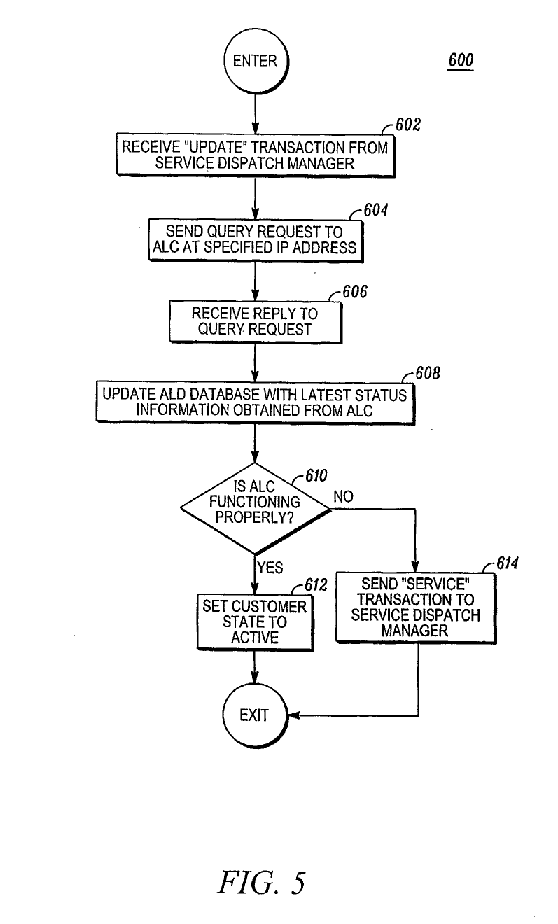

FIG. 5 illustrates an exemplary operational flow diagram 600 providing steps executed by the ALD server 100 (e.g., as part of the ALC manager 108) to confirm customer sign-up to the exemplary power load management system 10. The steps of FIG. 5 are preferably implemented as a set of computer instructions (software) stored in a memory (not shown) of the ALD server 100 and executed by one or more processors (not shown) of the ALD server 100. In accordance with the logic flow, the ALC manager 108 receives (602) an “Update” or similar transaction message or command from the service dispatch manager 126 and uses the IP address specified in the “Update” message to send (604) out a “Query Request” or similar message or command to the active load client 300. The “Query Request” message includes a list of devices the ALD server 100 expects to be managed. If the customer information input at customer sign-up includes temperature set points for one or more controllable, power consuming devices, that information is included in the “Query Request” message. The ALC manager 108 receives (606) a query reply containing information about the active load client 300 (e.g., current WiMax band being used, operational state (e.g., functioning or not), setting of all the counters for measuring current usage (e.g., all are set to zero at initial set up time), and/or status of devices being controlled (e.g., either switched to the “on” state or “off” state)). The ALC manager 108 updates (608) the ALD database 124 with the latest status information obtained from the active load client 300. If the ALC manager 108 detects (610), from the reply to the “Query Request” message, that the active load client 300 is functioning properly, it sets (612) the customer state to “active” to allow participation in ALD server activities. However, if the ALC manager 108 detects (610) that the active load client 300 is not functioning properly, it sends (614) a “Service” or similar transaction message or command to the service dispatch manager 126.

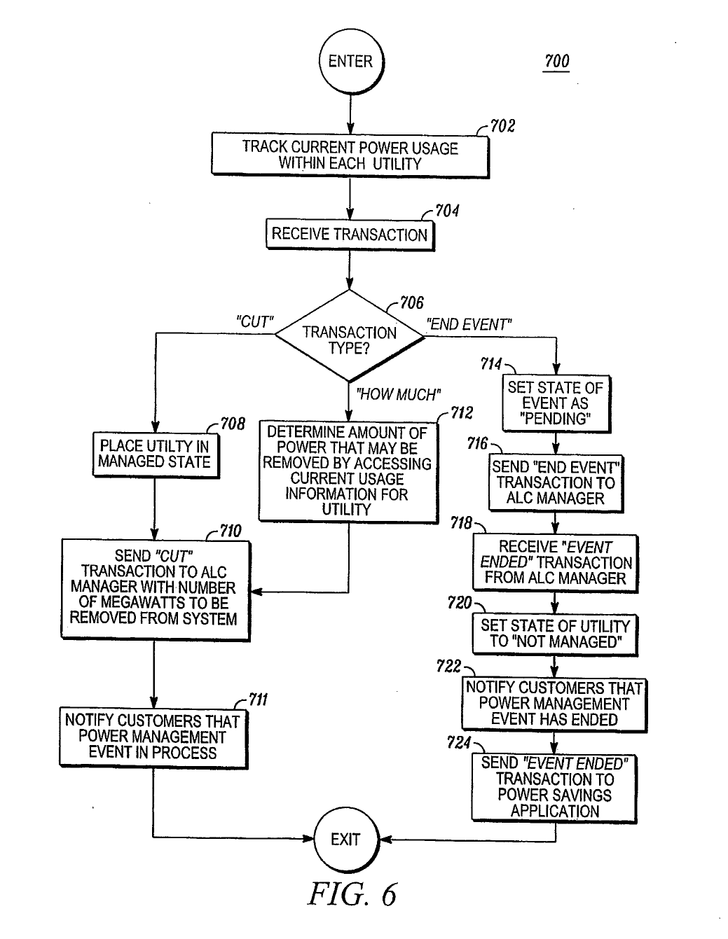

FIG. 6 illustrates an exemplary operational flow diagram 700 providing steps executed by the ALD server 100 (e.g., as part of the master event manager 106) to manage events in the exemplary power load management system 10. The steps of FIG. 6 are preferably implemented as a set of computer instructions (software) stored in a memory (not shown) of the ALD server 100 and executed by one or more processors (not shown) of the ALD server 100. Pursuant to the logic flow, the master event manager 106 tracks (702) current power usage within each utility being managed by the ALD server 100. When the master event manager 106 receives (704) a transaction message or command from the UCC command processor 104 or the ALC manager 108, the master event manager 106 determines (706) the type of transaction received. Upon receiving a “Cut” transaction from the UCC command processor 104 (resulting from a “Cut” command issued by the utility control center 200), the master event manager 106 places (708) the utility in a managed logical state. The master event manager then sends (710) a “Cut” transaction or event message or command to the ALC manager 108 identifying the amount of power (e.g., in megawatts) that must be removed from the power system supplied by the electric utility. The amount of power specified for reduction in a “Cut” command may be an instantaneous amount of power or an average amount of power per unit time. Finally, the master event manager 106 notifies (711) every customer that has chosen to receive a notification (e.g., through transmission of an email or other pre-established notification technique) that a power management event is in process.

Returning to block 706, when the master event manager 106 receives a “How Much” or other equivalent power inquiry transaction message or command from the UCC command processor 104 (resulting from a “How Much” or equivalent power inquiry command issued by the utility control center 200), the master event manager 106 determines (712) the amount of power that may be temporarily removed from a particular utility's managed system by accessing the current usage information for that electric utility. The current usage information is derived, in one embodiment, by aggregating the total available load for the electric utility, as determined from the customer usage information for the utility stored in the ALD database 124, based on the total amount of power that may have to be supplied to the utility's customers in view of the statuses of each of the active load clients 300 and their respectively controllable load devices 402-412, 420, 460 during the load control interval identified in the “How Much” message.

Each electric utility may indicate a maximum amount of power or maximum percentage of power to be reduced during any power reduction event. Such maximums or limits may be stored in the utility P&C database 134 of the ALD server 100 and downloaded to the master event manager 106. In one embodiment, the master event manager 106 is programmed to remove a default one percent (1%) of the utility's current power consumption during any particular power management period (e.g., one hour). In alternative embodiments, the master event manager 106 may be programmed to remove other fixed percentages of current power consumption or varying percentages of current power consumption based on the current power consumption (e.g., 1% when power consumption is at system maximum and 10% when power consumption is at only 50% of system maximum). Based on the amount of power to be removed, the master event manager 106 sends (710) a “Cut” or equivalent event message to the ALC manager 108 indicating the amount of power (e.g., in megawatts) that must be removed from the utility's power system (e.g., 1% of the current usage), and notifies (711) all customers that have chosen to receive a notification that a power management event is in process. The master event manager 106 also sends a response to the utility control center 200 via the UCC command processor 104 advising the utility control center 200 as to the quantity of power that can be temporarily reduced by the requesting utility.

Returning once again to block 706, when the master event manager 106 receives an “End Event” or equivalent transaction message or command from the UCC command processor 104 (resulting from an “End Event” command issued by the utility control center 200), the master event manager 106 sets (714) the state of the current event as “Pending” and sends (716) an “End Event” or equivalent transaction message or command to the ALC manager 108. When the ALC manager 108 has performed the steps necessary to end the present event (e.g., a power reduction or Cut event), the master event manager 106 receives (718) an “Event Ended” or equivalent transaction from the ALC manager 108 and sets (720) the utility to a logical “Not Managed” state. The master event manager 106 then notifies (722) each customer that has chosen to receive a notification (e.g., through transmission of an email or other pre-established notification mechanism) that the power management event has ended. Finally, the master event manager 106 sends an “Event Ended” or equivalent transaction message or command to the power savings application 120 and the utility control center 200 (via the UCC command processor 104).

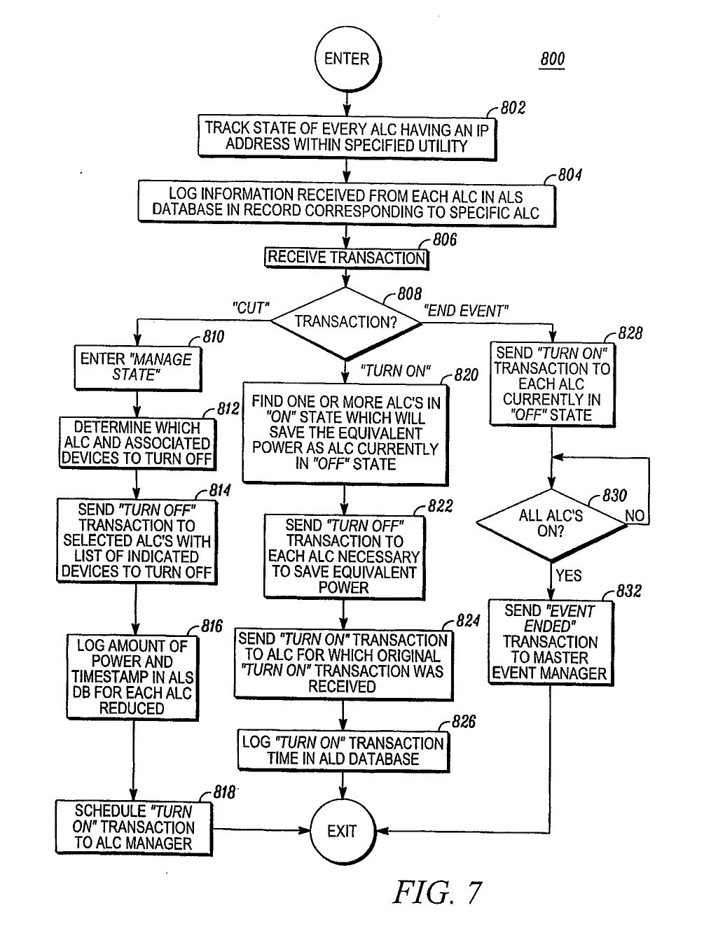

Turning now to FIG. 7, exemplary operational flow diagram 800 illustrates steps executed by the ALD server 100 (e.g., as part of the ALC manager 108) to manage power consumption in the exemplary power load management system 10. The steps of FIG. 7 are preferably implemented as a set of computer instructions (software) stored in a memory of the ALD server 100 and executed by one or more processors of the ALD server 100. In accordance with the logic flow, the ALC manager 108 tracks (802) the state of each managed active load client 300 by receiving messages, periodically or responsive to polls issued by the ALC manager 108, from every active load client 300 managed by the ALC manager 108. These messages indicate the present states of the active load clients 300. The state includes the present consumption of power for each controllable, power consuming device 402-412, 420 controlled by the active load client 300 (or the total power consumption for all controllable devices 402-412, 420 controlled by the active load client 300 if individual device metering is not available) and the status of each device 402-412, 420 (e.g., either “Off” or “On”). The ALC manager 108 stores or logs (804) the power consumption and device status information in the ALD database 124 in a record corresponding to the specified active load client 300 and its associated customer and serving utility.

When the ALC manager 108 receives (806) a transaction message from the master event manager 106, the ALC manager 108 first determines (808) the type of transaction received. If the ALC manager 108 receives a “Cut” or equivalent transaction message or command from the master event manager 106, the ALC manager 108 enters (810) a “Manage” logical state. The ALC manager 108 then determines (812) which active load clients 300 and associated devices 402-412, 420 operating on the utility specified in the “Cut” message to switch to the “Off” state. If a location (e.g., list of GPS coordinates, a GPS coordinate range, a geographic area, or a power grid reference area) is included in the “Cut” transaction message, only those active load clients 300 within the specified location are selected for switching to the “Off” state. In other words, the ALC manager 108 selects the group of active load client devices 300 to which the issue a “Turn Off” transaction message based at least partially on the geographic location of each active load client 300 as such location relates to any location identified in the received “Cut” transaction message. The ALD database 124 contains information on the present power consumption (and/or the average power consumption) for each controllable, power consuming device 402-412, 420 connected to each active load client 300 in the system 10. The ALC manager 108 utilizes the stored power consumption information to determine how many, and to select which, devices 402-412, 420 to turn off to achieve the power reduction required by the “Cut” message. The ALC manager 108 then sends (814) a “Turn Off” or equivalent transaction message or command to each active load client 300, along with a list of the devices to be turned off and a “change state to off” indication for each device 402-412, 420 in the list. The ALC manager 108 logs (816) the amount of power (either actual or average), as determined from the ALD database 124, saved for each active load client 300, along with a time stamp indicating when the power was reduced. The ALC manager 108 then schedules (818) transactions for itself to “Turn On” each turned-off device after a predetermined period of time (e.g., which may have been set from a utility specified default, set by instructions from the customer, or otherwise programmed into the ALC manager 108).

Returning back to block 808, when the ALC manager 108 receives a “Turn On” or equivalent transaction message or command from the master event manager 106 for a specified active load client 300, and the ALC manager is currently in a “Manage” state, the ALC manager 108 finds (820) one or more active load clients 300 that are in the “On” state and do not have any of their managed devices 402-412, 420 turned off (and are in the specified location if so required by the original “Cut” transaction message), which, when one or more of such devices 402-412, 420 are turned off, will save the same or substantially the same amount of power that is presently being saved by the specified active load clients that are in the “Off” state. Upon identifying new active load clients 300 from which to save power, the ALC manager 108 sends (822) a “Turn Off” or equivalent transaction message or command to each active load client 300 that must be turned off in order to save the same amount of power as the active load client(s) to be turned on (i.e. to have its or their managed devices 402-412, 420 turned on) or to save an otherwise acceptable amount of power (e.g., a portion of the power previously saved by the active load client(s) to be turned back on). The ALC manager 108 also sends (824) a “Turn On” or equivalent transaction message or command to each active load client 300 to be turned back on. The “Turn On” message instructs all active load clients 300 to which the message was directed to turn on any controllable, power-consuming devices that have been turned off, and causes the affected active load clients 300 to instruct their controllable devices 402-412, 420 to enable the flow of electric power to their associated power consuming devices (e.g., appliance, HVAC unit, and so forth). Finally, the ALC manager 108 logs (826) the time that the “Turn On” transaction message is sent in the ALD database 124.

Returning once again to block 808, when the ALC manager 108 receives an “End Event” or equivalent transaction message or command from the master event manager 106, the ALC manager 108 sends (828) a “Turn On” or equivalent transaction message or command to every active load client 300 which is currently in the “Off” state and is served by the serving utility identified in the “End Event” message or to which the “End Event” message relates. Upon determining (830) that all the appropriate active load clients 300 have transitioned to the “On” state, the ALC manager 108 sends (832) an “Event Ended” or equivalent transaction message or command to the master event manager 106.

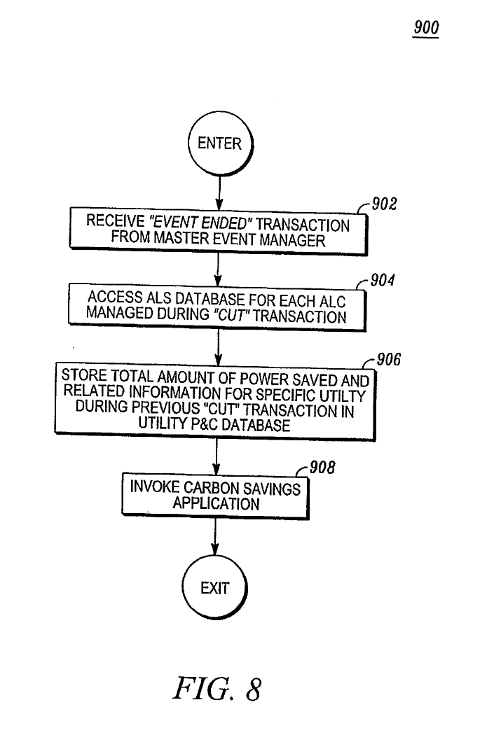

Referring now to FIG. 8, exemplary operational flow diagram 900 illustrates steps executed by the ALD server 100 (e.g., through operation of the power savings application 120) to calculate and allocate power savings in the exemplary power load management system 10. The power savings application 120 calculates the total amount of power saved by each electric utility for each Cut event and the amount of power saved by each customer possessing an active load client 300.

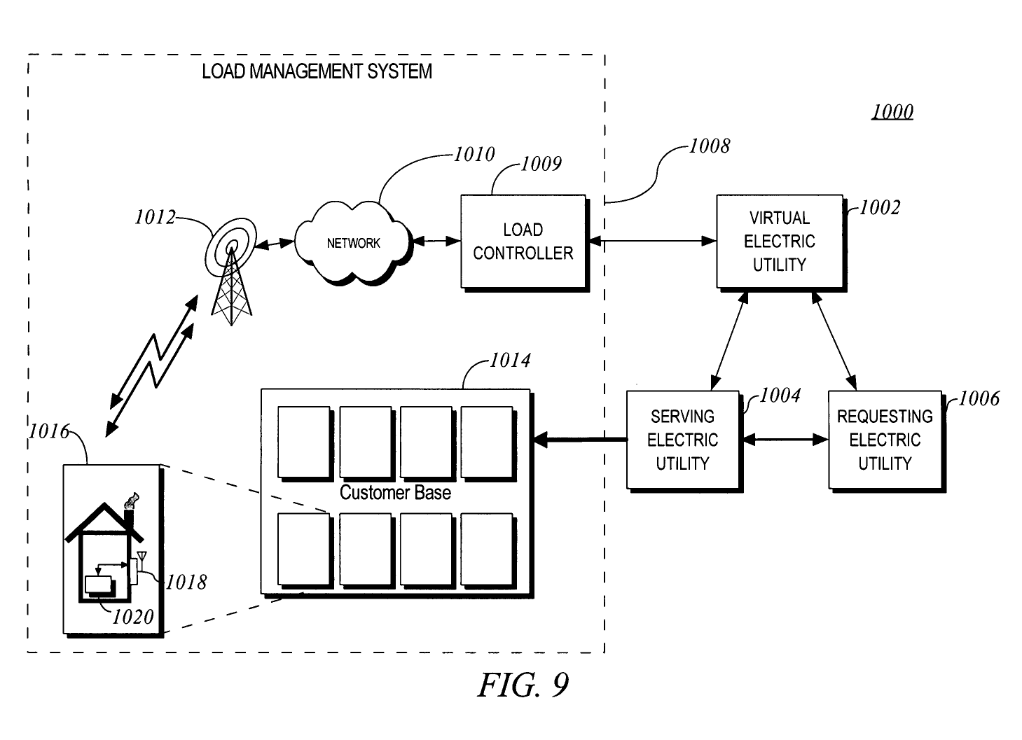

According to the logic flow of FIG. 9, the power savings application 120 receives (902) an “Event Ended” or equivalent transaction message or command from the master event manager 106 each time a “Cut” or power savings event has ended. The power savings application 120 then accesses (904) the ALD database 124 for each active load client 300 involved in the “Cut” event. The database record for each active load client 300 contains the actual amount (or average amount) of power that would have been used by the active load client 300 during the last “Cut” event, along with the amount of time that each controllable device 402-412, 420 associated with the active load client 300 was turned off. The power savings application 120 uses this information to calculate the amount of power (e.g., in megawatts per hour) that was saved for each active load client 300. The total power savings for each active load client 300 is stored in its corresponding entry in the ALD database 124. A running total of power saved is kept for each “Cut” transaction. Each electric utility that is served by the ALD server 100 has an entry in the utility P&C database 134. The power savings application 120 stores (906) the total amount of power (e.g., in megawatts per hour) saved for the specific utility in the utility's corresponding entry in the utility P&C database 134, along with other information related to the power savings event (e.g., the time duration of the event, the number of active load clients required to reach the power savings, average length of time each device was in the off state, plus any other information that would be useful in fine tuning future events and in improving customer experience). When all active load client entries have been processed, the power savings application 120 optionally invokes (908) the carbon savings application 132 or, analogously, a sulfur dioxide savings application or a nitrogen dioxide savings application, to correlate the power savings with carbon credits, sulfur dioxide credits or nitrogen dioxide credits, respectively, based on the geographic locations of the particular serving utility and customer. Additionally, in one embodiment, the carbon savings application 132 determines carbon credits based on government approved or supplied formulas and stores the determined carbon credits on a per customer and/or per utility basis.

Electric cooperatives and municipalities generally purchase power under long-term, defined pre-purchase wholesale contracts that guarantee a price per mega-watt hour for both peak and non-peak periods. In most cases, the pre-purchase price negotiated for these agreements are “take or pay” agreements that commit the electric cooperative or municipality to pay the serving utility a minimum amount of revenue, regardless of whether or not the actual energy demand is consumed. This arrangement provides the electric cooperative/municipality a sense of energy security based on the power generating utility's commitment to deliver power; however, it also allows the serving utility to sell excess power to other utilities connected to the FERC grid under peak load pricing, which is generally substantially higher per megawatt than the rate typically charged to customers under PUC-regulated pricing. This pricing arrangement is profitable for the serving utility, but generally, unless previously negotiated, these benefits are not passed on to the distribution partners, such as the electric cooperatives or the municipalities.

As detailed above, a power load management system, such as the exemplary system 10 described above, can be used to control power-consuming devices 402-412, 420 so as to defer or reduce power consumption associated with smaller, non-power generating electric utilities, such as electric cooperatives and municipalities. Through use of such power load management techniques, non-power generating electric utilities can aggregate unused electric power entitlements acquired under power supply agreements with power generating electric utilities and sell those entitlements, especially during peak power usage periods, to recoup a portion of the cost associated with purchasing electric power, thereby acting as a “virtual” power generating electric utility. In other words, using power load management methods such as those described herein, a virtual electric utility is able to sell its previously purchased, but unused, power allotment back to the power generating electric utility from which the power was originally bought (e.g., the power generating serving utility) or to a different electric utility through the FERC electrical grid as an alternative energy supply. Using the methods for active load management described above, or other methods for tracking actual power load deferment, the virtual electric utility has a known quantity of deferred electricity that may be sold on the open market or through pre-established arrangements. Because the virtual electric utility “generates” electrical energy virtually, as opposed to actually, in the form of conservation or load deferment by aggregating actual electrical load removed from an electric utility's network, the virtual electric utility may be classified under federal or state regulatory bodies as a wholesale or retail provider of electricity. The value of the actual power load shed from the grid may be considered to be equivalent to power generated (particularly during peak usage times).

Alternatively, one or more third parties can manage and operate the power load management system to accumulate or aggregate unused power based on the amount of actual power shed from the electrical grid. Such third parties function as virtual electric utilities that “generate” electrical energy virtually, as opposed to actually, in the form of conservation or load deferment by aggregating actual electrical load removed from an electric utility's network. In this case the virtual electric utility may be classified under federal or state regulatory bodies as a wholesale or retail provider of alternative energy allowing the third party to charge a tariff to electrical utilities seeking or required to purchase the deferred power from the third party. As discussed above, the value of the actual power load shed from the grid through operation of the power load management system may be considered to be equivalent to alternative power generated (particularly during peak usage times).

FIG. 9 depicts an exemplary alternative power generation system 1000 in accordance with one embodiment of the present invention. The exemplary alternative power generation system 1000 includes a virtual electrical utility 1002 to supply electrical power in a virtual manner to a requesting electric utility 1006 by deferring and then reselling previously purchased, but unused power, from a power generating entity (e.g., serving electric utility 1004). In one embodiment, the virtual electric utility 1002 communicates with an active load controller 1009 (e.g. an active load director 100 as described above) of a power load management system 1008 to track and control actual power used and/or deferred by individual subscribing customers 1016 within a customer base 1014 containing facilities that receive power purchased from and supplied by the serving electric utility 1004. In one embodiment, some or all of the operational functions of the virtual electric utility 1004 may be implemented within the load controller 1009.

In the load management system 1008, the load controller 1009 communicates with one or more client devices 1018 located at each customer facility 1016. Each client device may be implemented using an active load client 300 as described in detail above or any tele-metering device capable of exchanging messages with the load controller and controlling operation of one or more controllable, power consuming devices 1020 communicatively coupled thereto. The load controller 1009 may communicate with the client device 1018 either directly or through a network 1010 using the Internet Protocol (IP) or any other connection-based protocols. For example, the load controller 1009 may communicate using RF systems operating via one or more base stations 1012 (one shown) using one or more wireless communication protocols, such as GSM, EDGE, HSPA, LTE, TDMA, or CDMA data standards, including CDMA 2000, CDMA Revision A, CDMA Revision B, and CDMA EVDO Rev. A. Alternatively, or additionally, the load controller 1009 may communicate with the client device 1018 via a DSL-capable connection, cable television based IP-capable connection, or any combination thereof. In the exemplary embodiment shown in FIG. 9, the load controller 1009 communicates with the client devices 1018 using a combination of traditional IP-based communication (e.g., over a trunked line or through the Internet) to a base station 1012 and a wireless channel implementing the WiMax protocol for the “last mile” from the base station 1012 to the client device 1018. The client device 1018 communicates with at least one controllable, power consuming device 1020 to control the state of the power consuming device 1020 (e.g., “on” or “off”), the amount of power consumed by the device 1020 (e.g., the client device 1018 may set a thermostat setting on the device 1020 in the case where the device 1020 is an HVAC unit), and receive feedback from the device 1020.

In one embodiment in which at least some of the function of the virtual electric utility 1002 is implemented in a load controller 1009, such as the active load director 100, of the power load management system 1008, the virtual electric utility 1002 includes, among other things, a processor, a database, a load reduction report generator, and a communication interface. When the active load director 100 implements the functional aspects of the virtual electric utility 1002, the virtual utility's processor may be implemented by the UCC command processor 104 of the active load director 100 and the virtual utility's database may be implemented by the ALD database 124. Additionally, in this embodiment, the virtual utility's load reduction report generator may be implemented as part of the power savings application 120 and the communication interface may be implemented through the active load director's security interface 102. In one embodiment, communications between the virtual utility 1002 and other utilities 1004, 1006 occurs using a communication signaling protocol dedicated to communicating information related to supplying or acquiring electric power, such as power requirements information, power availability or deferment information, power deferred or saved in real time, and/or carbon credit information. The inter-utility communication signaling protocol is preferably analogous to the Signaling System 7 (SS7) protocol that is currently used for communications between telephone switches in a telecommunication system.

In accordance with one embodiment of the present invention, the virtual utility's processor is operable to receive requests to purchase electrical power (e.g., in the form of electric power entitlements or electric power deferments or conservation) from the other utilities 1004, 1006 in accordance with the dedicated communication signaling protocol. Alternatively, the requests may be communicated using a non-dedicated protocol, such as the Internet Protocol. The virtual utility's processor is also operable to issue power control commands into the load management system 1008 (.e.g., to client devices 1018) to control consumption of power by controllable, power consuming devices 1020, such as devices 402-412, 420 of FIG. 3. One such power control command is a power reduction command (e.g., a “Cut” command) issued to a client device 1018 requiring a reduction in the amount of electric power consumed by one or more of the power consuming devices 1020 under the client's device's control.

The virtual utility's database stores, on a client device-by-client device or customer-by-customer basis, information relating to power consumed by the power consuming devices 1020 during their operation. Using this information, the load reduction report generator creates a load reduction report detailing the amount of power saved or deferred through the processor's and the applicable client device's execution of one or more power reduction control commands. The report includes at least the total amount of power saved by all client devices 1018 executing the power reduction command, an identifier (e.g., IP address, GPS coordinates, electric meter base number or customer address) for each client device 1018 controlling power consuming devices 102 that had electrical power consumption reduced as a result of the power reduction command, and the amount of power saved or deferred on a client device basis.

Having executed one or more power reduction commands and aggregated a supply of deferred power (e.g., in the form of entitlements to electric power from a power generating entity from which the virtual utility receives its supply of actual electric power under a supply agreement), the virtual utility communicates an offer to sell some or all of its deferred or conserved power saved through execution of the power reduction command(s). The offer is preferably communicated via the communication interface using a dedicated inter-utility communication protocol. Alternatively, the offer may be communicated in any alternative manner, such as through email, website posting, instant messaging, oral communications, or otherwise. The power reduction command executed by the virtual utility may have been in direct response to receiving a request for power from another utility 1006 or may have been at a time when no power requests were pending to accumulate additional virtual power in the form of deferred or conserved power or electric power entitlements for later sale to a requesting utility 1006 or on the open market.

In operation, a requesting utility 1006 (which, in one embodiment, may be the power generating serving utility 1004 with which the virtual utility has a supply agreement) requests electric power from the virtual electric utility 1002 (e.g., by communicating the request over a network, such as a dedicated inter-utility network or otherwise). Typically, such a request would occur during periods of peak power use. Responsive to the request, the virtual utility 1002 may send the requesting utility 1006 power deferment information, such as availability of deferred power to be supplied/sold, amount of power that can be deferred in real time, and/or carbon credits associated with the deferred electric power available for sale. If sellable power is available, the virtual utility 1002 offers to sell the virtual utility's deferred or conserved power (e.g., in the form of an entitlement to certain electric power generated by the power generating entity with which the virtual utility has a supply agreement when the virtual utility is a municipality, electric cooperative or other electric power distributor, or in the form of deferred power as alternative energy when the virtual utility is an entity independent of the power generating entity and the distributing entity). If, upon receiving the request, the virtual utility 1002 does not already have previously aggregated, deferred or conserved power to sell, but has customers willing to participate in the load management system 1008, the virtual utility 1002 may, in real time, issue a power reduction command to obtain deferred power that may be offered to the requesting utility 1006. The offer to sell, if made by the virtual utility 1002, is received by the requesting utility 1006. Upon receiving the offer, the requesting utility 1006 either rejects the offer or purchases the deferred or conserved power (virtual power) from the virtual utility 1002.

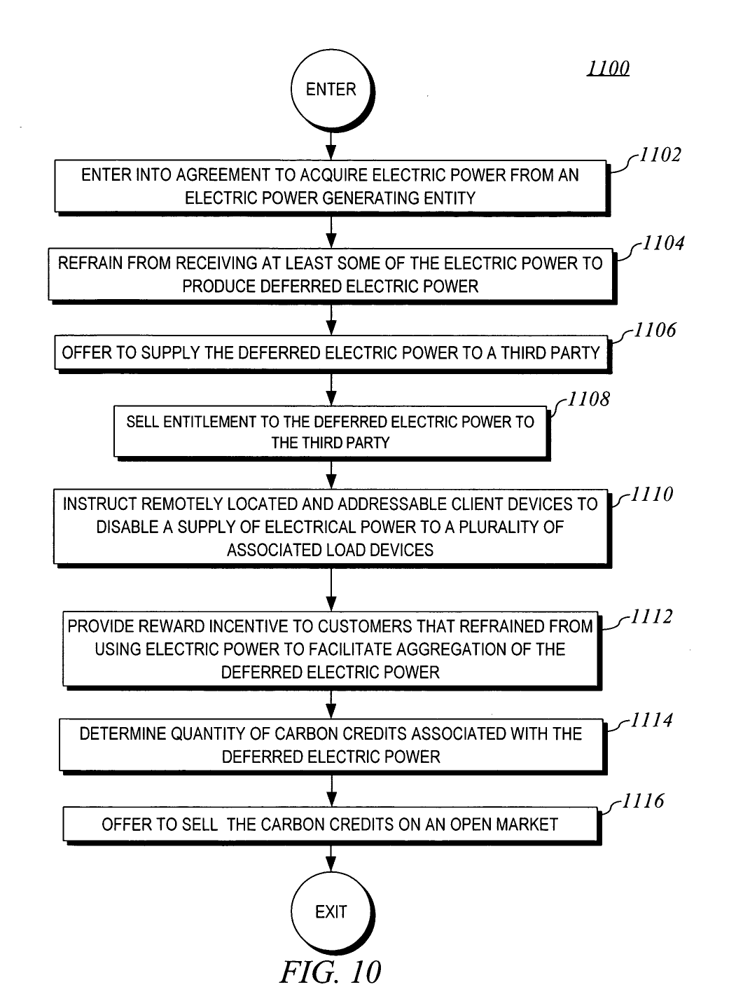

FIG. 10 illustrates an exemplary operational flow diagram 1100 providing steps executed by a virtual electric utility 1002 to provide alternative electrical power generation through deferred load consumption, in accordance with one embodiment of the present invention. According to this embodiment, the virtual electric utility 1002 enters (1102) into an agreement to acquire electric power from an electric power generating entity, such as an electric utility 1004 that generates power for a customer base 1014 serviced by the virtual electric utility 1002. The virtual electric utility 1002 may be, for example, an electric cooperative, a municipality, or any other non-power generating entity that distributes, sells, or otherwise supplies electrical energy to a customer base 1014 located in a specific geographic region. The customer base 1014 may include residences, small businesses, large businesses, or any facilities that require electric power. Generally, by the terms of the agreement, the virtual electric utility 1002 may agree to purchase a predetermined minimum amount of power over a predetermined period of time from the power generating entity (e.g., electric utility 1004), thereby entitling the virtual electric utility 1002 to a specific allotment of power from the power generating entity. During a term of the agreement, the virtual utility 1002 intentionally refrains (1104) from receiving at least some of the electric power to which it is entitled from the power generating entity to produce deferred electric power. The virtual electric utility 1002 then at least offers to supply (1106) this deferred power or some portion of it to a supplier of electric power, such as the power generating electric utility 1004 with which the virtual utility has a supply agreement, a different power generating electric utility 1006, a non-power generating electric utility (e.g., an electric cooperative or a municipality), or an electric power consuming entity (e.g., a business enterprise or a residential consortium, such as a homeowner's association). Typically, the offer to sell power to another electric utility will be made during or in anticipation of peak power consumption periods. The prices paid for the deferred power may be established ahead of time through agreements between the virtual utility 1002 and the buyer. Thus, the offer to sell the deferred power may be made prior to actual deferment of the power. As a result, block 1106 may occur before block 1104 in FIG. 10

In one embodiment, the virtual electric utility 1002 offers to sell and sells (1108) its entitlement to at least some of the deferred electric power to the purchaser at a price point at or above the current market price for “spot generation” or peak generation, or at or above the price that an electric power supplier is compelled to purchase electric from so-called “green” or environmentally-friendly power sources. The price point at which the power entitlements are sold should preferably be greater than, but at least equal to, the price at which the virtual electric utility 1002 is obligated to pay the power generating electric utility 1004 for electric power. In an exemplary embodiment, the virtual electric utility 1002 aggregates virtual power to sell or otherwise distribute by instructing (1110) remotely located and addressable client devices 1018 to disable or otherwise reduce a supply of electrical power to a plurality of associated power-consuming and controllable load devices 1020 (e.g., load devices 402-412, 420).

In order to facilitate aggregation of a surplus of deferred electric power, the virtual electric utility 1002 may provide (1112) rewards or reward incentives (e.g., similar to a frequent flyer or credit card rewards program) to its customers who refrain from using electric power to facilitate aggregation of the deferred electric power. Subscribing customers may use a web portal operated by or on behalf of the virtual utility to enroll in the rewards program, whereby customers earn points or credits based on the actual load consumption deferred by their individual use. For example, by installing a client device 1018 at the customer's premises, the supply of electric power to individual electrical devices may be controlled by an active load management system 1008, such as the load management system 10 described above with respect to FIGS. 1-8. Customers may sign-up to have specific appliances controlled by the load management system 1008 at specific time periods, or at an involuntary time period as determined by the load management system 1008 on an “as needed” basis. Detailed information relating to the actual amount of energy usage saved or deferred by each customer, each client device 1018, and/or each individually controlled device 1020 is relayed back to the load management system 1008 for storage in a database.

Each customer is awarded “points,” credits, or some numerical or like kind exchange currency, to trade or spend, distributed in proportion to the amount of energy deferred, reduced, shed or curtailed during the time interval that his or her controllable load devices 1020 were disabled to remove power from the electric grid. The method of calculating these credits would be at the discretion of the virtual utility 1002, the serving utility 1004, or some other reward redemption partner(s) of the virtual utility 1002. The accumulated points may be of a cash or non-cash nature. For example, a cash reward may be a preferable method for the serving utility 1004 so as to replace existing economic incentives offered to customers on current load management programs and thereby make such programs performance based (i.e. the more power shed, the greater the rewards). “Points” or non-monetary credits may be exchanged on a web-based commercial portal (e.g., the portal used by the customer to sign-up for load management), whereby goods and services of the virtual utility 1002 or any redemption partners may be exchanged or redeemed for reward points or credits. For example, the points may also be used to purchase power from the virtual electric utility 1002. Alternatively, the reward points may be exchanged for carbon credits or offsets or for credits or offsets relating to sulfur dioxide, nitrous oxide, mercury, or other greenhouse gas emissions.

Additionally, the virtual electric utility 1002 may provide further incentives to customers to subscribe for participation in the alternative power generation system 1000 by offering these customers the right, but not the obligation, to purchase the load control hardware (e.g., the client devices 1018) necessary to enact the business plan in exchange for equity incentives, such as non-voting shares of stock in the virtual utility enterprise. By offering customers an equity stake in the virtual utility 1002 in exchange for their purchase of the load control hardware, the virtual utility 1002 can substantially mitigate the economic impact of implementing the virtual utility function because the virtual utility 1002 would not have to incur the possibly substantial capital costs associated with acquiring the remotely located and addressable client devices 1018 used to implement an embodiment of the load management system 1008 through which the virtual utility 1002 can defer power consumption and/or acquire power entitlements for resale.

In a further embodiment, the virtual electric utility 1002 determines (1114) the amount of carbon credits or offsets, or alternatively credits or offsets relating to sulfur dioxide, nitrous oxide, mercury, or other greenhouse gas emissions, associated with the deferred electric power and may offer (1116) to sell at least some of the credits or offsets on an open market, under agreements with other electric utilities, or otherwise. For example, the virtual electric utility 1002 may trade or otherwise monetize the accumulated carbon, sulfur dioxide, nitrous oxide, mercury, or other greenhouse gas emissions credits or offsets through various commercial means, such as through one of the newly created credit or offset trading exchanges that have recently emerged on the European and American commodities exchanges. Alternatively, the virtual utility may agree to sell or offer to sell its carbon credits, sulfur dioxide credits or nitrogen dioxide credits, as applicable, to other electric utilities, including, for example, the power generating utility with which the virtual utility has entered in to a electric power supply agreement.

The amount of carbon credits or offsets, or alternatively the amount of sulfur dioxide, nitrous oxide, mercury or other greenhouse gas emission credits or offsets, accumulated by deferring power consumption is a function of the amount of power deferred in combination with the generation mix of the serving utility 1004 that actually provides electricity to customers within a pre-defined geographic area. The generation mix identifies the fuel sources for the overall capability of each serving utility 1004 to provide electricity at any given time. For instance, a serving utility 1004 may obtain 31% of its overall capacity from burning coal, 6% from oil, 17% from nuclear facilities, 1% from hydroelectric plants, and the remaining 45% from natural gas or other so-called clean technology or “clean tech” power generating techniques, such as solar power or wind power. The generation mix is generally known real time by the serving utility; however, due to the inherent delay associated with using the utility's transmission grid to convey power to and from various FERC-grid interconnected locations, historical data regarding the generation mix may be used to compute carbon credit calculations on a delayed or non-real time basis after the actual events of conservation, trading or generation of the electricity. Alternatively, carbon credits or offsets, or credits or offsets for other greenhouse gas emissions, may be determined by the virtual utility in real time based on real time generation mix data from the serving utility 1004.

Because carbon credits relate only to the amount of carbon burned, each fuel type has a different carbon credit rating. Consequently, the carbon value is determined by the make-up of the fuel sources for the serving utility 1004. Actual carbon credits accumulated by power load deferment may be calculated, for example, using methods described above in connection with the carbon savings application 132 or through other commercially viable load management or curtailment methods to determine the actual load consumption deferred by each customer. Carbon credits or offsets, or credits or offsets for other greenhouse gas emissions, may be calculated based on the Kyoto Protocol, according to federal or state mandated methods, or according to a method agreed upon by an association or group of electric utilities.

Additionally, the carbon credits or other fuel or gaseous emissions-based credits may be calculated and allocated on a customer-by-customer basis or cumulatively for the virtual electric utility 1002. When allocated on a customer-by-customer basis, each customer may sell or exchange the carbon or other credits or offsets resulting from that customer's participation in the load management system 1008. When the credits are retained by the virtual utility 1002, the virtual utility 1002 may exchange the carbon or other credits with other electric utilities using a dedicated inter-utility communication signaling protocol, as discussed above.

Additionally, the customer reward points and carbon or other fuel or gaseous emissions-based credits may be exchanged on other commodity exchanges resembling carbon trading exchanges but not necessarily directly related to carbon credits. An example of this type of exchange would be environmentally friendly companies providing “phantom carbon credits” in exchange for actual carbon credits that are retained by the virtual utility 1002 and its trading partners.

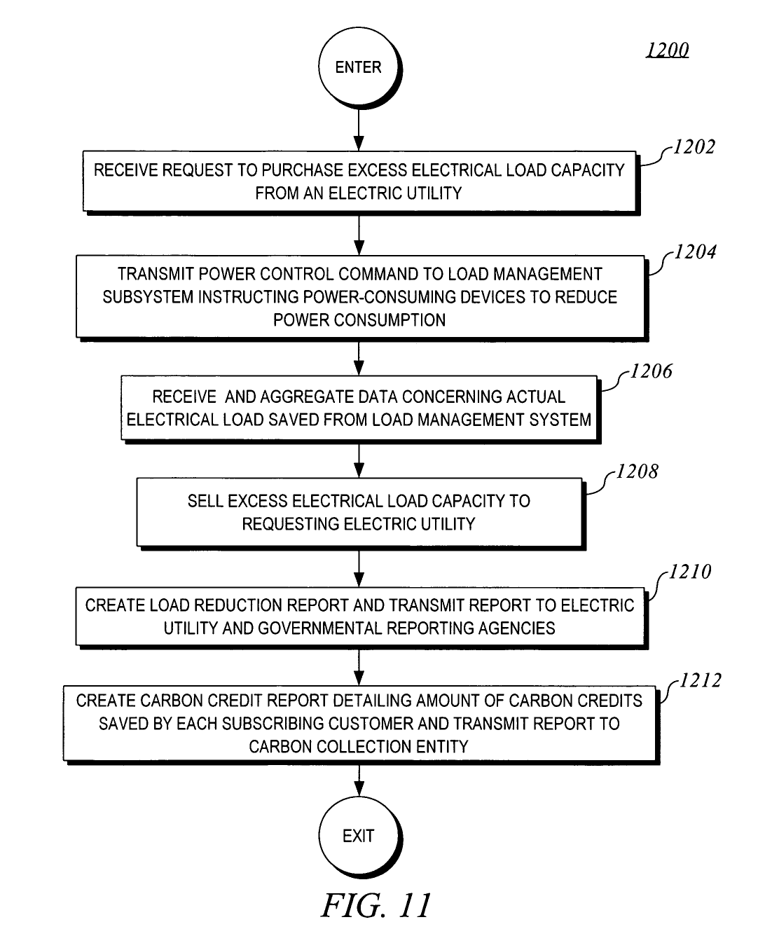

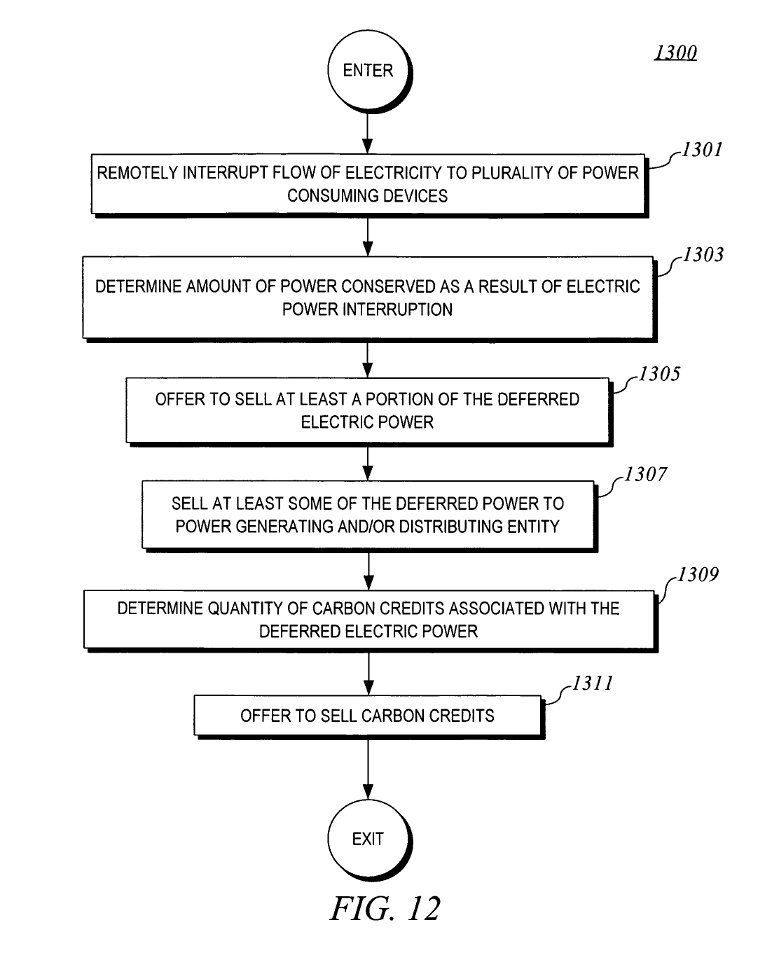

FIG. 11 illustrates an exemplary operational flow diagram 1200 providing steps executed by a virtual electric utility 1002 to provide alternative electrical power generation through deferring load consumption, in accordance with another embodiment of the present invention. The virtual electric utility 1002 receives (1202) a request to purchase excess electrical load capacity from an electric utility or electric power consumer in need of power. The requesting entity may be the actual serving utility 1004 with which the virtual utility 1002 has entered into a supply agreement (e.g., during a time interval when the serving utility 1004 needs to generate additional power), a different electric utility 1006, or an electric power consuming entity. The virtual electric utility 1002 accumulates excess capacity, either prior to receiving the request or in real-time responsive to receiving the request, by transmitting (1204) or otherwise issuing a power control command to a load management system 1008 (e.g., through an IP network) instructing the load management system 1008 to temporarily reduce power consumption of one or more individually controllable power-consuming devices 1020.

The active load management system 1008 generates data from each client device 1018 affected by the power reduction command identifying the amount of power that was deferred by the client device 1018 or each load device 1020 under the client device's control. The data may include an identifier (e.g., IP address, equipment serial number or other identifier, GPS coordinates, physical address, and/or electrical meter identification information) for the client device 1018 and/or each individually controllable load device 1020. Additionally, the data may include the actual or estimated amount of power saved for each controllable load device 1020 and/or the total amount of power saved for each customer or client device 1018 on a per customer or per client device basis. The actual amount of power saved by each client device 1018 or each controllable load device 1020 may be determined using information provided by the load device manufacturers concerning load and power consumption characteristics of the load device 1020 or the various load devices 1020 under the client device's control, an electric power consumption value measured at the time of the client device's or load device's installation, or actual power consumption information read from an electrical meter monitoring the load device 1020 or the client device 1018. The load management system 1008 transfers this data or a report containing this data to the virtual electric utility 1002. The virtual electric utility receives (1206) the data or report, which contains information relating to the amount of electric power deferred, conserved, or shed as a result of execution of the power control command and optionally the amount of power deferred or conserved by each client device 1018 and/or each controllable load device 1020 as a result of execution of the power control command.

The virtual electric utility then sells (1208) or at least offers to sell the saved or deferred electricity (e.g., excess load capacity) to other electric utilities or electric power consuming entities at a rate that is preferably at or above the current market value for peak or spot generation, or at least greater than or equal to the price which the virtual electric utility 1002 is obligated to pay the power generating electric utility 1004 for the electricity (e.g., when the virtual utility 1002 is a power distribution entity, such as a municipality or an electric cooperative, or a power wholesale entity).

Using the data or report received from the load management system 1008, the virtual electric utility 1002 may create (1210) a verifiable load reduction report, which may be transmitted via a network to an electric utility requesting power from the virtual utility 1002, the power generating serving electric utility 1004, and/or any other entity, such as appropriate state and federal governmental agencies (e.g., FERC or a state public utilities commission). Additionally, the virtual electric utility 1002 may use this data to create (1212) a carbon credit report detailing the amount of carbon credits or other fuel or gaseous emissions-based credits or offsets accrued by the virtual utility 1002 or each customer of the virtual utility based at least on the amount of power deferred by all the client devices 1018 served by the virtual utility 1002 or each client device 1018 served by the virtual utility 1002, as applicable, and a generation mix of the deferred power. The carbon or other fuel or gaseous emissions-based credits or offsets may by determined as provided under the Kyoto Protocol or any other state, federal, or inter-utility formula based at least on the amount of power deferred and the generation mix of the deferred power, as well as optionally on the geographic location of the virtual utility 1002 or the client devices 1018 (e.g., the premises location of the customer at which the client device 1018 is installed or positioned). Determining carbon credits or other fuel or gaseous emissions-based credits or offsets earned on a per client device basis enables the determination of such credits on a per customer basis since one or more client devices are positioned at each customer premises. The determined amount of carbon or other credits may be communicated by the virtual utility 1002 to a credit or offset trading entity (e.g., an exchange) to facilitate exchanging or selling the credits with other electrical utilities or investors.

Additionally, the virtual utility 1002 may provide reward points or other incentives to its customers to participate in the power deferment process. Such points may be based on the location of the customer's premises, the amount of power deferred by the client device(s) 1018 located at the customer's premises, and the cost of electrical power during the time interval that the customer's client device 1018 has been instructed to reduce or disable electrical power consumption by the load devices 1020 it is controlling. For example, because the cost of power during peak load periods is generally higher than during non-peak load periods, more points can be obtained through power reduction or deferment during peak load periods. As detailed above, the points can be exchanged for products and services of the virtual utility 1002 or any other redemption partner by telephone, a web portal, or any other means.

FIG. 12 illustrates an exemplary operational flow diagram 1300 providing steps executed by a virtual electric utility 1002 to provide alternative electrical power generation through deferring load consumption, in accordance with a further embodiment of the present invention. In this embodiment the virtual utility 1002 does not intervene into the relationship of the serving utility 1006 directly as a retailer, but rather intervenes only in the aggregation of power saving, independent of the power generating utility 1004 and the serving utility 1006, for purposes of selling conserved power back to any electric utility (e.g., including the serving utility 1006 or the power generating utility 1004) or any electric power consumer (e.g., a business enterprise, a residential entity, such as a homeowner's association, or otherwise). According to this embodiment, the virtual electric utility 1002 controls a power load management system 1008 to remotely interrupt (1301) the flow of electric power to multiple power consuming devices 1020 on a scheduled basis or on an as-need basis. The power interruptions are preferably limited in duration in a manner similar to the operation of the power load management system 10 detailed above with respect to FIGS. 1-8. In one embodiment as detailed above, the virtual utility 1002 instructs (e.g., by issuing power control commands) remotely located and addressable client devices 1018 to disable/enable a supply of electrical power to the controllable, power consuming load devices 1020 that are under the control of the client devices 1018.

After or during the time period when the flow of electric power is being or has been interrupted to the selected power consuming devices 1020, the virtual utility 1002 determines (1303) an amount of power conserved or deferred as a result of the interruption of the flow of electric power to the selected power consuming devices 1020 to produce an amount of deferred electric power. Pursuant to the embodiment in which a load management system 1008 issues power control commands to remote client devices 1018, the amount of deferred power may be determined by aggregating the amounts of power disabled by the client devices 1018, and thereby conserved by the power consuming devices 1020, during a particular time period (e.g., an hour, a month, a year, or any other period). Once a desired amount of deferred power has been accumulated, the virtual utility 1002 at least offers to sell (1305) some or all of the deferred electric power to an entity that generates electric power (e.g., a power generating utility), an entity that distributes electric power (e.g., an electric cooperative or municipality), and/or an entity that consumes electric power. In one embodiment, the deferred electric power is offered for sale by the virtual utility 1002 to one or more power generating, distributing, and/or consuming entities at a price generally paid for peak or spot power generation, which price is preferably higher than the price charged under long-term power purchase agreements. If a buyer is interested in purchasing some or all of the deferred power from the virtual utility 1002 at an agreed upon price, the virtual utility 1002 sells (1307) the deferred electric power, or a portion thereof, to the buyer at the agreed upon price. Such prices may be established ahead of time through agreements between the virtual utility 1002 and the buyer. Thus, the offer to sell the deferred power may be made prior to actual deferment of the power. As a result, block 1305 may occur before block 1301 in FIG. 12.

Besides determining the amount of deferred or conserved power resulting from the virtual utility's operation of the load management system 1008, the virtual utility 1002 may additionally determine (1309) a quantity of carbon credits or offsets, or credits or offsets for other greenhouse gas emissions, such as sulfur dioxide, nitrous oxide, or mercury, earned by the virtual utility and/or its individual customers (e.g., on a customer-by-customer basis) based at least on the amount of deferred electric power and a generation mix of the deferred power. The generation mix information is preferably obtained as detailed above, for example, from the publicly submitted or otherwise obtained records of the power generating utility or power distribution utility that is actually supplying electric power to those customers having power consuming devices 1020 managed by the load management system 1008. If such information is provided in real time (e.g., using a dedicated inter-utility communication protocol or public data protocol), the virtual utility 1002 can compute carbon or other credits or offsets in real time upon determining the amount of deferred power. On the other hand, if generation mix information is not available in real time, carbon or other credit or offset determination may be made on a delayed basis once the generation mix information is available. In addition to the amount of conserved or deferred power and generation mix, the amount of carbon or other credits or offsets earned may be based on geographic location depending on the formula used for credit or offset determination. Carbon or other credits or offsets may be determined using various formulas as described above. After the carbon or other credits or offsets have been determined, some or all of the credits or offsets may be offered for sale (1311) either privately or on an open market as described above.

In a further embodiment, incentives may be provided to customers to participate in the load management system 1008 and carbon credits may be determined on a per customer basis or for the virtual utility 1002 as detailed above with respect to FIGS. 9-11. For example, redeemable points or credits may be given to customers participating in the load management system 1008, which credits or points may be redeemed through a web portal or otherwise as discussed above. Additionally or alternatively, the owner of the virtual utility 1002 may offer equity incentives (e.g., non-voting shares of stock) to customers in exchange for their purchase of the client devices 1018 to thereby defer capital investment costs associated with deployment of the load management system 1008. Further, all the other features and attributes of the virtual utility 1002 as described above with respect to FIGS. 9-11 are equally applicable to the virtual electric utility as implemented in accordance with the logic flow of FIG. 12.

As described above, the present invention encompasses a method and apparatus for implementing a virtual power generating utility. With this invention, electric cooperatives, municipalities, or other electric power supplying entities may act as a virtual power generating utility by intentionally refraining from receiving electric power purchased from a power generating entity under a supply agreement and conveying their entitlements to that deferred power to another electric utility for adequate consideration. Alternatively, independent third parties outside the conventional power distribution chain may act as virtual electric utilities that generate alternative energy in the form of deferred or conserved power that can be sold to conventional power generating or distributing entities on an as-needed basis, especially during periods of peak power consumption. Under such an alternative scenario, the third party operates a load management system the controls the state of controllable, power consuming load devices located at customers' premises in such a manner so as to shed, conserve or otherwise defer the consumption of power and thereby virtually generate electric power in an amount equal to the amount of power deferred through operation of the load management system. Thus, non-power generating entities can become alternative power generation sources by selling their power entitlements or deferred power to other utilities or even end-user customers on an as-needed basis, such as during peak power consumption periods. The present invention also contemplates incentives to customers for participation in a load management system through which the virtual utility can control and accumulate an amount of deferred power to make available for exchange with other electric utilities

In the foregoing specification, the present invention has been described with reference to specific embodiments. However, one of ordinary skill in the art will appreciate that various modifications and changes may be made without departing from the spirit and scope of the present invention as set forth in the appended claims. For example, the disclosed load management system is applicable for managing the distribution of power from utility companies to subscribing customers using any number of IP-based or other communication methods. Additionally, the functions of specific modules within the ALD server 100, active load client 300, and/or virtual electric utility 902 may be performed by one or more equivalent means. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made during the pendency of this application and all equivalents of those claims as issued.

What is claimed is:

1. A method for providing a virtual electric utility, the method comprising:
entering into an agreement to acquire electric power from an electric power generating entity;
during a term of the agreement, intentionally refraining from receiving at least some of the electric power to produce deferred electric power; and
at least offering to supply the deferred electric power to at least one of an electric power supplier and an electric power consumer.

2. The method of claim 1, wherein the step of at least offering to supply the deferred electric power comprises:
offering to sell, to the at least one of the electric power supplier and the electric power consumer, an entitlement to the deferred electric power.

3. The method of claim 2, wherein the agreement provides that the electric power is acquired at a first price, the step of offering to sell comprises:
offering to sell, to the at least one of the electric power supplier and the electric power consumer, an entitlement to the deferred electric power for a second price that is greater than or equal to the first price.

4. The method of claim 2, wherein the electric power supplier is the electric power generating entity.

5. The method of claim 1, further comprising:
providing rewards to customers that refrained from using the electric power to facilitate aggregation of the deferred electric power.

6. The method of claim 5, further comprising:
providing a web portal to facilitate an exchange of the rewards for goods and services.

7. The method of claim 1, wherein the step of intentionally refraining from receiving at least some of the electric power comprises the step of:
instructing remotely located and addressable client devices to disable a supply of electrical power to a plurality of associated controllable load devices.

8. The method of claim 7, further comprising:
determining an aggregate amount of power disabled by the remotely located and addressable client devices to produce the deferred electric power.

9. The method of claim 7, further comprising:
offering equity incentives to customers of the virtual utility in exchange for purchasing the remotely located and addressable client devices.

10. The method of claim 1, further comprising:
determining a quantity of carbon credits associated with the deferred electric power; and
offering to sell at least some of the carbon credits.

11. The method of claim 10, wherein the step of determining a quantity of carbon credits comprises determining a quantity of carbon credits based at least on a generation mix of the deferred electric power and a geographic area to which the electric power is supplied.

12. The method of claim 10, wherein the step of determining a quantity of carbon credits comprises determining a quantity of carbon credits on a customer-by-customer basis.

13. The method of claim 1, wherein the step of intentionally refraining from receiving at least some of the electric power comprises:
receiving a request for electric power from the electric power supplier, the request indicating an amount of electric power desired; and
responsive to the request, intentionally refraining from receiving at least some of the electric power.

14. The method of claim 13, wherein the request is received electronically in accordance with a communication signaling protocol dedicated to communication of power-related information between electric utilities.

15. The method of claim 14, further comprising:
responsive to the request, sending power deferment information to the electric power supplier in accordance with the communication signaling protocol, the power deferment information including at least one of availability of electric power to be deferred, amount of the deferred electric power in real time, and carbon credits associated with the deferred electric power.

16. The method of claim 14, further comprising:
exchanging at least one of carbon credits and power entitlements with at least one electric utility utilizing the communication signaling protocol.

17. A method for implementing a virtual electric utility, the method comprising:
issuing a power control command to a load management system, the load management system positively controlling power consumed by a plurality of remotely located and controllable load devices, the power control command instructing the load management system to temporarily reduce electrical power consumption by at least some of the controllable load devices;
responsive to issuance of the power control command, receiving a report from the load control management system that includes at least an amount of electric power deferred as a result of execution of the power control command; and
at least offering to sell the deferred amount of electric power to at least one of an electric utility and an electric power consumer.

18. The method of claim 17, wherein the load management system includes a plurality of client devices, each client device controlling one or more controllable load devices of the plurality of controllable load devices, and wherein the report further includes amounts of electric power deferred on a client device-by-client device basis.

19. The method of claim 18, wherein each of the plurality of client devices is positioned at a premises location associated with a corresponding customer of the virtual utility, the method further comprising:
determining an amount of carbon credits earned by each customer of the virtual utility based at least on the premises location of the corresponding customer, an amount of power deferred by the client device positioned at the premises location of the corresponding customer, and a generation mix of the power deferred by the client device.

20. The method of claim 17, wherein the step of at least offering to sell the deferred amount of electric power comprises:
selling the deferred amount of electric power to at least one of the electric utility and the electric power consumer at a price that is greater than or equal to a price at which the virtual utility agreed to buy electric power from a power generating entity.

21. The method of claim 17, further comprising:
determining an amount of carbon credits earned by the virtual utility based at least on the deferred amount of electric power and a generation mix of the deferred electric power.

22. The method of claim 21, further comprising:
communicating the amount of carbon credits to a carbon trading entity to facilitate exchanging carbon credits with other electrical utilities.

23. The method of claim 19, further comprising:
providing reward points to each customer of the virtual utility based on a location of the premises of the customer, the amount of power deferred by the client device, and a current cost of electrical power during the time interval that each client device has been instructed to reduce electrical power consumption.

24. A virtual electric utility that supplies electrical power to other electric utilities through conveyance of entitlements to electric power sourced by a power generating entity, the virtual electric utility comprising:
a processor operable to receive requests from the other electric utilities to purchase electrical power and to issue power control commands to a load management system that controls a plurality of power consuming devices, the load management system including a plurality of remotely located and controllable client devices that each controls one or more of the plurality of power consuming devices; at least one of the power control commands requiring a reduction in an amount of electric power consumed by the plurality of power consuming devices;
a database for storing, on a per client device basis, information relating to power consumed by the plurality of power consuming devices during operation of the plurality of power consuming devices;
a load reduction report generator, operably coupled to the database and responsive to the processor, for creating a load reduction report that includes a total amount of power saved through execution of a power reduction control command, an identifier for each client device controlling power consuming devices that had electrical power consumption reduced as a result of the power reduction control command, and an amount of power deferred in connection with each client device participating in the load management system; and
a communication interface, operably coupled to the processor, for communicating with the other electric utilities to at least offer to sell an entitlement to the total amount of power saved through execution of the power reduction control command.

25. A method for acquiring power from a virtual electric utility on an as-needed basis, the method comprising:
requesting electric power from the virtual electric utility;
receiving, from the virtual electric utility, an offer to sell an entitlement to electric power generated by at least one power generating entity; and
purchasing the entitlement from the virtual electric utility.

26. A method for providing a virtual electric utility, the method comprising:
remotely interrupting a flow of electric power to a plurality of power consuming devices;
determining an amount of power conserved as a result of the interruption of the flow of electric power to the plurality of power consuming devices to produce deferred electric power; and
at least offering to sell at least a portion of the deferred electric power to at least one of an entity that generates electric power, an entity that distributes electric power, and an entity that consumes electric power.

27. The method of claim 26, wherein the step of at least offering to sell at least a portion of the deferred electric power further comprises:
selling the at least a portion of the deferred electric power to at least one of an entity that generates electric power, an entity that distributes electric power, and an entity that consumes electric power at a price associated with a purchase of peak power generation.

28. The method of claim 26, further comprising:
determining a quantity of carbon credits earned by the virtual utility based at least on the deferred electric power and a generation mix of the deferred electric power; and
offering to sell at least some of the carbon credits.

29. The method of claim 28, wherein the step of determining a quantity of carbon credits comprises determining a quantity of carbon credits on a customer-by-customer basis.

30. The method of claim 26, wherein the step of remotely interrupting a flow of electric power to a plurality of power consuming devices comprises the step of:
instructing remotely located and addressable client devices to disable a supply of electrical power to a plurality of associated controllable load devices; and
wherein the step of determining an amount of power conserved as a result of the interruption of the flow of electric power to the plurality of power consuming devices comprises the step of:
determining an aggregate amount of power disabled by the remotely located and addressable client devices to produce the deferred electric power.

31. The method of claim 30, further comprising:
offering equity incentives to customers of the virtual utility in exchange for purchasing the remotely located and addressable client devices.
